(19) United States
(12) Patent Application Publication
(10) Pub. No.: US 2025/0354808 A1
(43) Pub. Date: Nov. 20, 2025

(54) SYSTEMS AND METHODS FOR CARBON DIOXIDE ESTIMATION

(71) Applicant: AIDash Inc., San Jose, CA (US)

(72) Inventors: Stephen A. Marland, Warwickshire (GB); Mohamed Musthafa, Tami Nadu (IN); Pritesh Jain, Karnataka (IN)

(73) Assignee: AIDash Inc., San Jose, CA (US)

(21) Appl. No.: 19/212,590

(22) Filed: May 19, 2025

Related U.S. Application Data
(60) Provisional application No. 63/648,917, filed on May 17, 2024.

(51) Int. Cl. G01C 15/00

(52) U.S. Cl. CPC G01C 15/002

(57) ABSTRACT

In some embodiments, a method involves receiving remote data of a geographic area, generating a canopy height model from digital surface and terrain data, identifying individual trees using a segmentation model that integrates optical and LiDAR data, determining tree heights from the canopy height model, converting heights to diameter at breast height (DBH) values, classifying tree species by segregating them by family and identifying species, calculating biomass using DBH, height, and species-specific factors, and estimating carbon dioxide sequestration based on the calculated biomass.

### CROSS-REFERENCE TO RELATED APPLICATION

This application claims priority to U.S. Provisional Patent Application No. 63/648,917 filed on May 17, 2024, and entitled “Systems and Methods for Carbon Estimation,” which is incorporated in its entirety herein by reference.

### FIELD OF THE INVENTION(S)

Embodiments of the present invention(s) are generally related to carbon dioxide estimation for natural areas including trees, and in particular, identifying changes of natural storage of carbon dioxide for a particular natural environment.

### BACKGROUND

Carbon sequestration is one of the vital natural processes to store atmospheric carbon-dioxide thereby playing a key role in regulation of climate parameters. Various methods have been developed for carbon estimation process like in situ methods—destructive or non-destructive.

While there are numerous protocols (e.g., Woodland Carbon Code) for the determination of woodland carbon they follow a similar procedure. Existing protocols employ a four step manual process that then uses statistics for extrapolating from a series of samples recorded within the woodland. In step 1, the woodland is manually stratified by a specialist into broad compartments to establish the differing “Strata” in the woodland. This process splits the woodland into relatively homogenous topological and habitat areas (similar tree species, age profile, canopy, and undergrowth characteristics). The area for each Strata is recorded from the mapping desk study.

In step 2, the specialist undertakes manual sample measurements within each strata by physically visiting the locations. The specialist records a number of samples, including the number of trees, height, measurement of Diameter at Breast Height (DBH), and tree species. The sample protocol is defined by the standard. For example, the specialist identifies a random plot sample and marks a centre point as sample point. In one example, a 10 m distance from the centre point is used to define the sample area (radius of 10 m circle). All trees (above 1.5 m) are recorded with a unique reference and measurements are taken. Some protocols will also record values for new growth (saplings, young trees less than 1.5 m), kept separate from the main calculations but added back after calculating the Carbon/biomass for each Strata.

In step 3, the samples and measurements are used to calculate the average Carbon/biomass for the areas measured giving a Carbon/biomass value per unit of area and then such value is extrapolated to the full area of each Strata. In step 4, the Strata values are combined to provide the overall woodland Carbon/biomass value at that point in time.

### SUMMARY

An example non-transitory computer-readable medium comprises executable instructions. The executable instructions may be executable by one or more processors to perform a method comprising: receiving remote sensing data of the geographic area, generating a canopy height model using digital surface model (DSM) data and digital terrain model (DTM) data, identifying individual trees in the geographic area using a tree segmentation model that combines optical and LiDAR data to determine boundaries of individual tree canopies, determining heights of the identified individual trees using the canopy height model, converting the heights to diameter at breast height (DBH) values, classifying species of the identified individual trees using a species classification model that segregate identified trees, classify them by family, and then identify species, calculating biomass for each of the identified individual trees based on the DBH values, the heights, and species-specific factors, and calculating carbon dioxide sequestration based on the calculated biomass.

In some embodiments, the species-specific factors include at least one of: species-specific tariff constants, species-specific gravity values, and crown/root biomass expansion factors. The method may further comprise receiving ground-based sample measurements for a subset of trees in the geographic area and calibrating at least one of the tree segmentation model and the species classification model using the ground-based sample measurements.

In various embodiments, the method further comprising receiving temporal remote sensing data of the geographic area captured at different time periods and calculating changes in carbon sequestration over time based on the temporal remote sensing data. Calculating biomass may comprise calculating trunk biomass using tree volume and species-specific gravity, calculating crown biomass using species-specific crown biomass expansion factors, and calculating total biomass as a sum of the trunk biomass and the crown biomass. In some embodiments, calculating carbon sequestration comprises: calculating carbon as a proportion of the calculated biomass and calculating carbon dioxide equivalent by multiplying the calculated carbon by a conversion factor.

The method may further comprise: stratifying the geographic area into homogeneous regions based on tree characteristics; calculating carbon sequestration for each of the homogeneous regions and combining carbon sequestration values for the homogeneous regions to determine total carbon sequestration for the geographic area. In some embodiments, the species classification model is trained using labeled data for tree species prevalent in the geographic area.

An example system may comprise at least one processor and memory containing executable instructions. The executable instructions may be executable by the at least one processor to: receive remote sensing data of the geographic area, generate a canopy height model using digital surface model (DSM) data and digital terrain model (DTM) data, identify individual trees in the geographic area using a tree segmentation model that combines optical and LiDAR data to determine boundaries of individual tree canopies, determine heights of the identified individual trees using the canopy height model, convert the heights to diameter at breast height (DBH) values, classify species of the identified individual trees using a species classification model that segregate identified trees, classify them by family, and then identify species, calculate biomass for each of the identified individual trees based on the DBH values, the heights, and species-specific factors, and calculate carbon dioxide sequestration based on the calculated biomass.

An example method may comprise receiving remote sensing data of the geographic area, generating a canopy height model using digital surface model (DSM) data and digital terrain model (DTM) data, identifying individual trees in the geographic area using a tree segmentation model that combines optical and LiDAR data to determine boundaries of individual tree canopies, determining heights of the identified individual trees using the canopy height model, converting the heights to diameter at breast height (DBH) values, classifying species of the identified individual trees using a species classification model that segregate identified trees, classify them by family, and then identify species, calculating biomass for each of the identified individual trees based on the DBH values, the heights, and species-specific factors, and calculating carbon dioxide sequestration based on the calculated biomass.

### BRIEF DESCRIPTION OF THE DRAWINGS

FIG. 1 depicts an example environment in which a hazard tree identification system may operate in some embodiments.

FIG. 2 depicts a block diagram of the hazard tree identification system in some embodiments.

FIG. 3A depicts trees at various stages and at various classifications determined by the hazard tree identification system in some embodiments.

FIG. 3B depicts a geographic area where electrical assets may be located in some embodiments.

FIG. 3C depicts a zoomed-in portion of the geographic area of FIG. 3B.

FIGS. 4A and 4B depict example software code that may be utilized by the hazard tree identification system in some embodiments.

FIG. 5 is a diagram depicting a method for identifying hazard trees in some embodiments.

FIG. 6 is a diagram depicting another method for identifying hazard trees in some embodiments.

FIG. 7 depicts an image for a geographic area that may be utilized by the hazard tree identification system in some embodiments.

FIG. 8A depicts an example processing block for processing images according to some embodiments.

FIG. 8B depicts an example test-time augmentation framework that the hazard tree identification system may utilize in some embodiments.

FIG. 9 depicts an example convolutional neural network that the hazard tree identification system may utilize to classify pixels of images in some embodiments.

FIG. 10 depicts a representation of a classification data structure that the hazard tree identification system may have generated based upon processing the image of FIG. 7 in some embodiments.

FIG. 11 depicts polygons representing hazard trees superimposed on the image of FIG. 7 that may be generated by the hazard tree identification system in some embodiments.

FIG. 12 depicts a table containing hazard trees identified by the hazard tree identification system in some embodiments.

FIG. 13 depicts an example user interface that the hazard tree identification system may generate and provide in some embodiments.

FIG. 14 is a flow diagram depicting a method for identifying hazard trees in some embodiments.

FIG. 15 depicts a block diagram of an example digital device in some embodiments.

FIG. 16 illustrates a block diagram of a carbon dioxide estimation system 1600 in some embodiments.

FIGS. 17A and 17B is a system diagram for estimating carbon dioxide in a natural environment in some embodiments.

FIG. 18 depicts an overview of a biomass/carbon estimation in some embodiments.

FIG. 19 depicts examples of a tree height map, tree segmentation, and a species map generated by the systems and methods discussed with regard to FIGS. 17A and 17B in some embodiments.

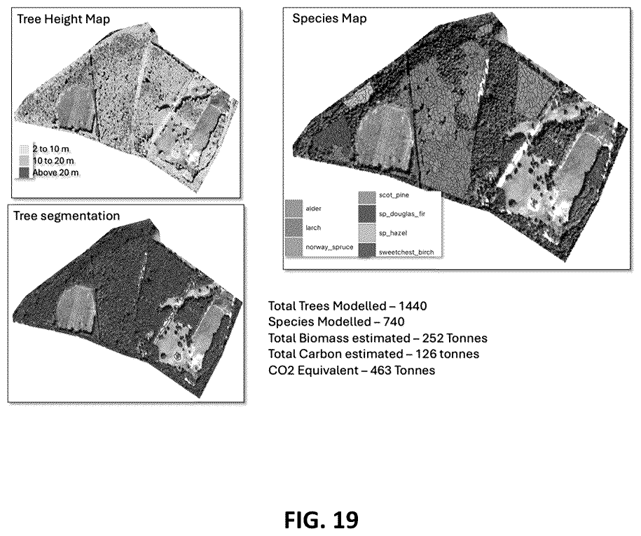

FIG. 20 depicts example code that may be utilized to create and/or populate a database that may store values for tariff number and crown and/or root biomass calculations.

FIG. 21 depicts example code that may be utilized to process remote sensing data such as satellite images.

FIG. 22 depicts example code that may be utilized to perform biomass and/or carbon calculations.

Throughout the drawings, like reference numerals will be understood to refer to like parts, components, and structures

### DETAILED DESCRIPTION

One problem with manual inspection of electrical assets (e.g., transformers, poles, transmission lines, distribution lines, and/or the like) is the inability of utility personnel to inspect all vegetation that may impact functionality. The problem is compounded when the utility supports a huge amount of territory. Moreover, utility personnel often inspect utilities in poor conditions (for example, cold, heat, rain, snow, or the like). Further, utility personnel may not be sufficiently trained. For these reasons, manual inspection can be inaccurate, missing information, misleading, costly, and take considerable time. Inaccurate information, missing information, and delays can also create unanticipated risks of wildfires and service failure which can lead to widespread damage and loss of life.

Accordingly, it would be advantageous to have scalable systems and methods for identifying hazardous trees and determining whether such trees are potential hazards to utility assets such as transmission lines and distribution lines. It would be further advantageous to be able to classify utility assets according to the risks to the utility assets posed by hazard trees.

Various embodiments of a hazard tree identification system and associated methods and non-transitory computer-readable media as described herein may provide technical solutions to these and other technical problems. The hazard tree identification system may process images of geographic areas that include electrical assets of utilities to identify hazard trees. In some embodiments, the hazard tree identification system may determine heights of hazard trees, distances of the hazard trees to electrical assets, and other attributes of hazard trees. The hazard tree identification system may use this and other information to determine whether or not hazard trees represent potential hazards to the electrical assets. In some embodiments, the hazard tree identification system also determines classifications or categories of risk for the electrical assets.

It will be appreciated that various embodiments of the hazard tree identification system and associated methods and non-transitory computer-readable media correct problems caused by current approaches or technology. For example, current approaches or technologies may result in not identifying certain hazard trees or not appropriately categorizing the risk to electrical assets posed by hazard trees.

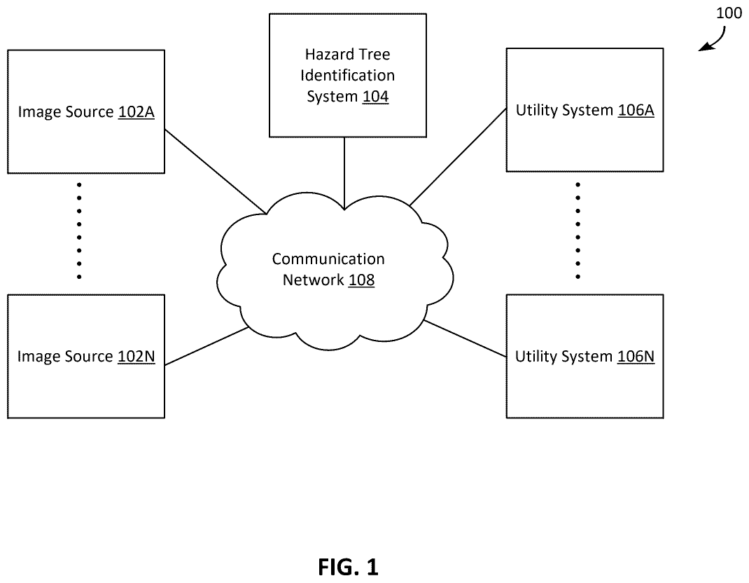

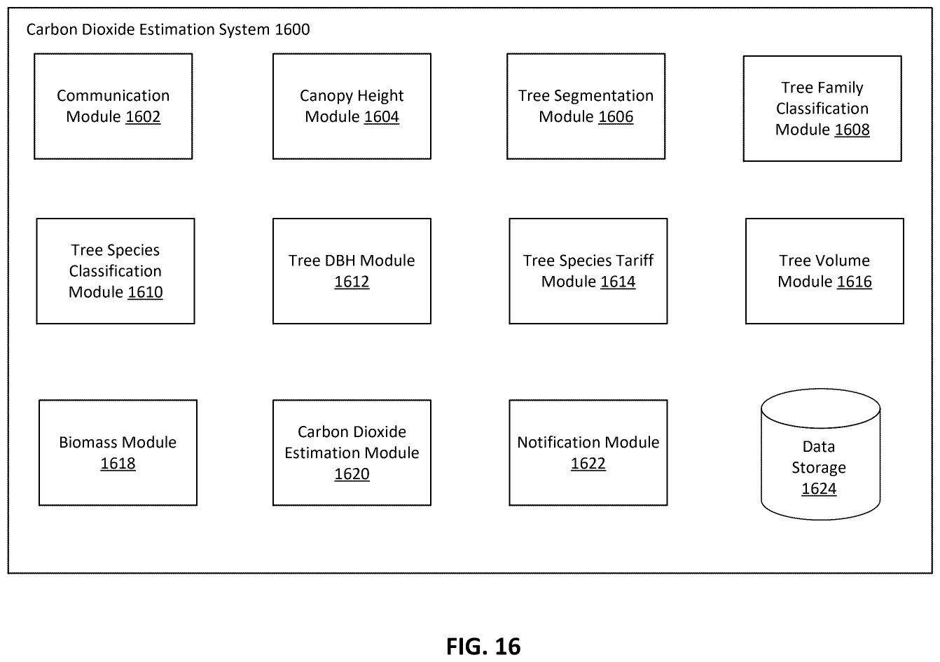

FIG. 1 depicts an example environment 100 in which a hazard tree identification system may operate in some embodiments. The environment 100 includes multiple image sources 102A through 102N (which may be referred to as an image source 102 or as image sources 102), multiple utility systems 106A through 106N (which may be referred to as a utility system 106 or as utility systems 106), a hazard tree identification system 104, and a communication network 108. Each of the image sources 102, the hazard tree identification system 104, and the utility systems 106 may be or include any number of digital devices. A digital device is any device with at least one processor and memory. Digital devices are discussed further herein, for example, with reference to FIG. 15.

Image sources 102A to 102N may each be a third party system configured to provide images or access to images. Different third parties may periodically capture images of geographic areas. For example, some third parties may obtain images of geographic areas from satellites, airplanes, helicopters, and/or drones at regular intervals or on-demand for a variety of purposes. Satellite images are images of Earth collected by imaging satellites operated by governments and businesses. Different third parties may obtain images from different sources (for example, different satellites, airplanes, helicopters, drones, or the like) for the same and/or different geographic regions. An example of a third party that captures, collects, and/or provides images covering geographic regions is Airbus. The third parties may provide images and/or license access to the images to other businesses for a variety of purposes (e.g., via one or more image sources 102A-102N).

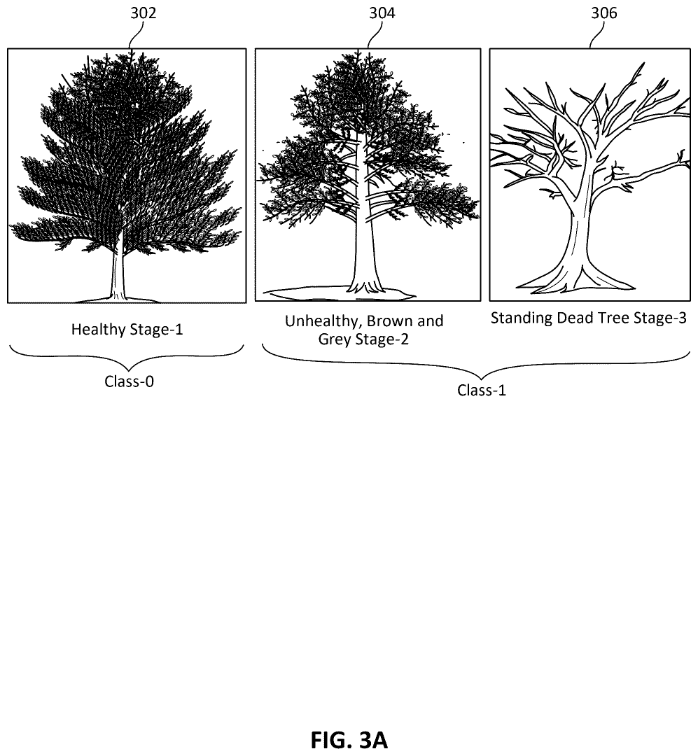

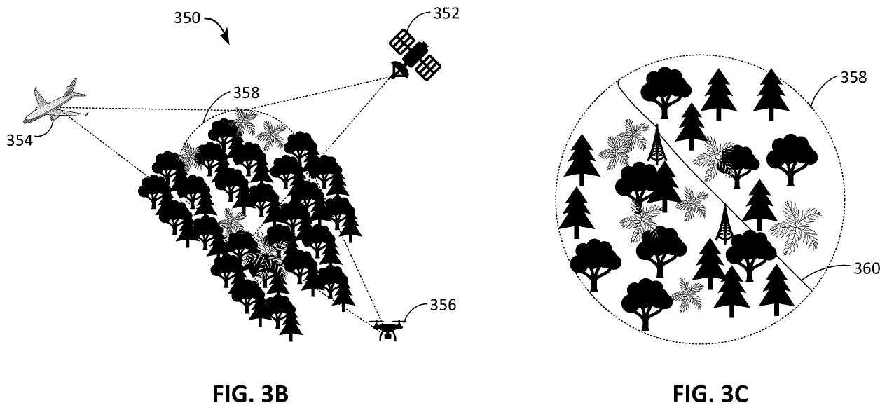

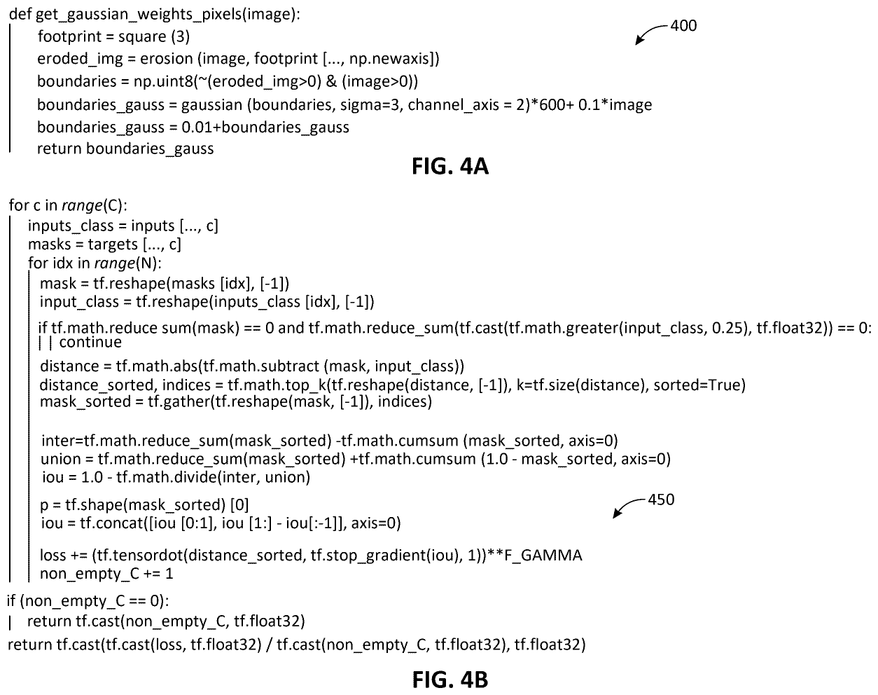

FIG. 3B depicts a geographic area 350 where electrical assets may be located in some embodiments. Images of the geographic area may be captured by, for example, a satellite 352, an aircraft 354, and/or a drone 356. Captured images and/or other information (e.g., geographic coordinates and the like) may be stored and provided to others via one or more image sources 102A-102N.

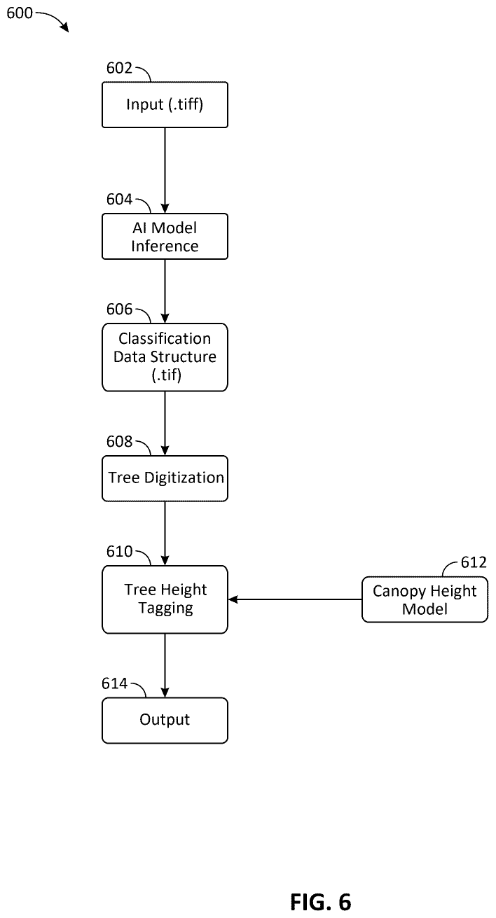

FIG. 3C depicts an example zoomed-in portion 358 of the geographic area 350 of FIG. 3B, containing an electrical asset 360, which includes an electrical powerline, such as a transmission line or a distribution line. As discussed further herein with reference to, for example, FIG. 5, the hazard tree identification system 104 may calculate distances between electrical assets, such as the electrical asset 360, and vegetation proximate to electrical assets, such as hazard trees.

Returning to FIG. 1, in some embodiments, any number of the image sources 102A-N may obtain images of the same geographic area (e.g., from satellites, aircraft, and/or drones) and save them over time. As such, an image source 102A may obtain and store images of the same geographic site taken on different days, months, or years. For example, an image source 102A may provide images at a first duration of time (for example, taken at a particular time and date). The image source 102A may also provide images of the same geographic areas for a second duration (for example, taken at a different particular time or date, such as one or more years before or after the first duration).

Any number of the image sources 102A-N may provide application programming interfaces (APIs) to enable another system (for example, the hazard tree identification system 104) to request images for a particular geographic area (for example, all or part of a geographic region). The request may be or include a request for current images and/or for images of the same geographic areas taken at different times. In various embodiments, the hazard tree identification system 104 may request information on what geographic area images are available and at what time frames. A geographic area may be any portion of the surface of the earth. In various embodiments described herein, a geographic area includes assets. For example, electrical assets of a power distribution infrastructure, alternatively referred to as an electrical network infrastructure, may be in a geographic area.

The hazard tree identification system 104 may be configured to receive images of any number of geographic areas. The hazard tree identification system 104 may utilize the images to identify hazard trees that may interfere with the safety and operation of assets of a local distribution network and/or a high-voltage distribution network (which alone or together may be referred to herein as an electrical network). An asset of an electrical network may include, for example, one or more transmission lines, distribution stations, feeder lines, circuit spans, segments, poles, transformers, substations, towers, switches, relays, and/or the like (which may be referred to herein as electrical assets).

The hazard tree identification system 104 may be described herein as identifying hazard trees. It will be appreciated that the hazard tree identification system 104 may identify any hazardous vegetation, including any number of different types of vegetation (not just trees but also including shrubs, bushes, vines, and/or the like).

In various embodiments, the hazard tree identification system 104 may enhance, orient, and analyze (for example, using artificial intelligence (AI) and/or machine learning (ML) systems) geographic images to identify trees and/or vegetation in the images. In some embodiments, the hazard tree identification system 104 may estimate the heights of trees, their crown areas, their volumes, and/or their densities. The hazard tree identification system 104 may plot the vegetation (such as trees) on maps and/or provide shapefiles that include information regarding vegetation, such as the location, shape, and attributes of vegetation. Such shapefiles may be utilized in Geographic Information System (GIS) software.

In various embodiments, the hazard tree identification system 104 may request current satellite images from third parties, such as businesses or governments that operate imaging satellites, and utilize the images to identify hazard trees. The hazard tree identification system 104 may request other satellite, airplane, helicopter, and/or drone images for the same geographic areas from the same and/or different image sources (e.g., image sources 102A-102N), combine the images from different image sources for the same geographic areas and then analyze the information to identify potential threats to electrical assets and/or other information.

Utilizing satellite, airplane, helicopter, and/or drone images provides significant advantages over manual viewing from the ground. For example, in addition to case in obtaining the images, it will be appreciated that satellite images may have sufficient spatial resolution (e.g., 30 centimeters (cm)×30 cm) for evaluating vegetation such as trees. The spatial resolution may refer to the size of a geographic area on the Earth represented by one pixel of the satellite image. For example, a 30 cm×30 cm spatial resolution may mean each pixel of the satellite image represents a 900 square centimeter area.

Different aerial or satellite images may have different spatial resolutions. In one example, a set of satellite images has a spatial resolution of 50 cm×50 cm. In some embodiments, satellite images have spatial resolutions other than 30 cm×30 cm and 50 cm×50 cm. The hazard tree identification system 104 may utilize satellite images that have spatial resolutions ranging from approximately 5 cm×5 cm to approximately 50 cm×50 cm. Due to cost constraints and/or image availability, the hazard tree identification system 104 may receive images of the same area with different spatial resolutions. The hazard tree identification system 104 may modify certain satellite images to conform to a standard resolution.

In some embodiments, the hazard tree identification system 104 may utilize artificial intelligence and/or machine learning, such as a trained convolutional neural network (CNN), to improve the quality of captured images using histogram modification, contrast enhancement, and/or bilinear interpolation to generate high-resolution images from low-resolution images. U.S. patent application Ser. No. 17/160,231 filed on Jan. 27, 2021, and entitled “SYSTEM AND METHOD OF INTELLIGENT VEGETATION MANAGEMENT,” describes such utilization of artificial intelligence and/or machine learning and is incorporated in its entirety herein by reference.

Satellite images may be captured using red-green-blue (RGB) bands as well as an infrared (IR) band. The cost of satellite imagery may be high. Accordingly, images captured using other image capture forms may be considered. In some terrains, such as residential areas with many mature trees obscuring transmission lines, a spatial resolution lower than 30 cm×30 cm may be insufficient. The cost of satellite imagery may make this imagery solution too expensive and prohibitive. To obtain images of terrains with a spatial resolution of higher than 30 cm×30 cm may require other forms of image capture, such as drones. Drones, however, may have a limited flight time, and therefore, the area of the physical environment captured by drones may be less than that of a satellite.

Images may also be captured using an airplane, sometimes referred to as aviation photography, or by a helicopter, a drone, or other airborne vehicle. Similar to satellite images, images captured using airplanes, helicopters, drones, and the like (generally referred to as aerial images) may be licensed or captured on-demand by private companies. Aerial images may have a higher spatial resolution than satellite images and may provide another source of digital images for the hazard tree identification system 104.

To account for the differences in image capture angles resulting from different forms of image capture, such as satellites, airplanes, helicopters, and drones, the hazard tree identification system 104 may receive images of the same area captured by different image capture methods. In some embodiments, the hazard tree identification system 104 may utilize images from different methods of image capture to correct for different image capture angles, enhance the information contained within the images, and add information for more accurate analysis. The hazard tree identification system 104 may utilize artificial intelligence and/or machine learning algorithms or models to correct the image capture angles, which may distort objects captured in the images.

In various embodiments, due to environmental factors such as cloud coverage, smoke, or fog, a satellite may require more than one flyover to capture satellite images, or an airplane, helicopter and/or drone may require more than one pass to capture aerial images of a particular area. The hazard tree identification system 104 may utilize artificial intelligence and/or machine learning algorithms or models to recognize features on each of the multiple images of the particular area. Similarly, the hazard tree identification system 104 may utilize artificial intelligence and/or machine learning algorithms or models, such as a CNN, to improve the quality of captured images by using contrast enhancement. In some embodiments, the hazard tree identification system 104 may receive satellite imagery of the same area over several years and use that information to estimate the growth of trees in that area and generate an estimate of a future schedule of vegetation management. Vegetation management may include any activity pertaining to vegetation proximate to utility assets, such as inspection, removal, and pruning.

In various embodiments, the hazard tree identification system 104 may correlate utility equipment and/or transmission line location information with images captured using various forms of image capture to identify an estimated location of electrical assets (e.g., utility equipment or transmission lines). The hazard tree identification system 104 may receive this information from the utility system 106. In one embodiment, the hazard tree identification system 104 may determine the location of transmission lines or utility equipment using feature recognition of an artificial intelligence and/or machine learning model.

In some embodiments, if the estimated height of vegetation such as a hazard tree is generally greater than or equal to a distance between the tree and an electrical asset, the hazard tree identification system 104 may identify the vegetation as a potential hazard and provide a notification to the utility system 106 of the potentially hazardous vegetation. In some embodiments, the hazard tree identification system 104 may rank the geographic areas contained within a geographic region based on the potentially hazardous vegetation and the facilities served by the utility system 106 (for example, residences, businesses, government and/or public health facilities) that are within the geographic areas. The hazard tree identification system 104 may provide notifications of the ranked geographic areas to the utility system 106.

The utility system 106 may be responsible for the management, control, and/or alerts regarding a power distribution infrastructure, also referred to as an electrical network infrastructure. A power distribution infrastructure may be or include any network of transmission lines, including electrical assets for the generation, transmission, and distribution of electricity. An electrical asset may be or include any component of the electrical network, including, for example, transmission lines, distribution stations, feeder lines, circuit spans, segments, poles, transformers, substations, towers, switches, relays, and/or the like. In some embodiments, the utility system 106 may be operated by a utility company that owns the utility equipment and/or transmission lines, such as the Pacific Gas and Electricity Company (PG&E). It will be appreciated that there can be any number of utility systems 106. Although FIG. 1 depicts a utility system 106, it will be appreciated that there may not be a utility system 106 but any system (or any number of different utility systems management by any number of related or unrelated entities) that tracks or enables management of vegetation, debris, or other asset care.

Although electrical networks are specifically discussed herein, it will be appreciated that embodiments discussed herein may be applied to any infrastructure, including, for example, gas lines, pipelines, buildings, roads, highways, and/or the like.

In some embodiments, the communication network 108 may represent one or more computer networks (for example, LAN, WAN, and/or the like). The communication network 108 may provide communication between any of the image sources 102, the hazard tree identification system 104, and any of the utility systems 106. In some implementations, the communication network 108 comprises computer devices, routers, cables, and/or other network topologies. In some embodiments, the communication network 108 may be wired and/or wireless. In various embodiments, the communication network 108 may comprise the Internet, one or more networks that may be public, private, IP-based, non-IP based, and so forth.

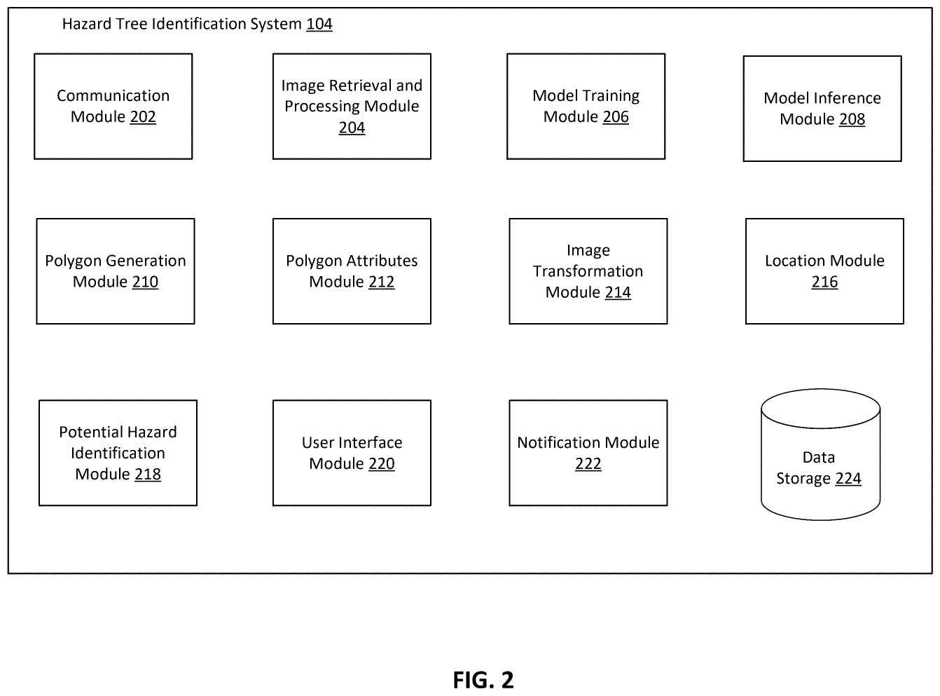

FIG. 2 depicts a block diagram of the hazard tree identification system 104 according to some embodiments. The hazard tree identification system 104 includes a communication module 202, an image retrieval and processing module 204, a model training module 206, a model inference module 208, a polygon generation module 210, a polygon attributes module 212, an image transformation module 214, a location module 216, a potential hazard identification module 218, a user interface module 220, a notification module 222, and a data storage 224.

The communication module 202 may send and receive requests or data between any of the image sources 102, the hazard tree identification system 104, and any of the utility systems 106. The communication module 202 may receive a request from a user of the hazard tree identification system 104 (for example, via an interface) to request images from the image source 102. In some embodiments, the communication module 202 may provide an interface or information for a remote interface to enable a third party (for example, a utility, a vegetation management company, workers, supervisors, contractors, insurance companies, and/or the like) to view and manage vegetation and other safety activities.

In some embodiments, the image retrieval and processing module 204 may retrieve images or video from any number of multiple image sources 102. In one example, an image source 102 may provide satellite, aerial and/or ground-level images and video. The images or video may be captured by different devices, such as satellites, airplanes, drones, image capture devices, surveillance cameras, and the like. Commercially available satellite images from businesses that operate imaging satellites may provide a user interface or a web link to download satellite images of specific geographic areas.

In various embodiments, the image retrieval and processing module 204 may interact with one or more of the image sources 102 to retrieve different images of the same geographic area and/or different geographic areas. For example, the image retrieval and processing module 204 may retrieve one set of images taken by satellite(s) of a geographic area that is available through one image source 102 and other images taken by an airplane of the same geographic area that is available through another image source 102.

In some embodiments, the image retrieval and processing module 204 may request images based on a geographic area (for example, the coordinates of the geographic area), location information, date ranges, quality (for example, high quality or based on resolution), enhancement, orientation, and/or the like.

In various embodiments, the image retrieval and processing module 204 may provide an Application Programming Interface (API) call to a software application that provides satellite images. In some embodiments, the image retrieval and processing module 204 may receive enhanced and aligned images from a satellite image source. In various embodiments, the image retrieval and processing module 204 may determine if images require enhancement. In some embodiments, the image retrieval and processing module 204 may utilize computer vision techniques and deep learning models to determine if the quality of images may be improved.

In some embodiments, the image retrieval and processing module 204 may optionally scan any number of images, remove noise, remove undesired markings provided by the service, improve accuracy, balance or remove color, or the like. In some embodiments, the spatial resolution of images captured by the different image sources 102 is different. The image retrieval and processing module 204 may utilize techniques such as histogram equalization, contrast enhancement, bilinear interpolation, or some combination thereof to generate high-resolution images from low-resolution images and/or to standardize image resolutions.

The image retrieval and processing module 204 may also process images to normalize intensity values of pixels of the images to a standard range. The image retrieval and processing module 204 may also process images by calculating various statistical measures of intensity values (for example, 50th percentile and/or 90th percentile of intensity values).

The model training module 206 may train one or more artificial intelligence (AI) and/or machine learning (ML) models. In some embodiments, the model training module 206 may train a fully convolutional neural network (which may also be referred to as a fully convolutional segmentation model). In embodiments where the one or more AI and/or ML models include one or more fully convolutional neural networks, the one or more fully convolutional neural networks may be based on a UNet architecture which includes an encoder and a decoder. The encoder may utilize a backbone (for example, ResNet50v2) that has been trained on images from an ImageNet dataset, which may include millions of images. The decoder may include five layers of a convolutional neural network that may be up sampled using nearest point interpolation.

The model inference module 208 may perform inference on images for a geographic area using the one or more AI and/or ML models trained by the model training module 206. For example, the model inference module 208 may utilize a deep learning convolutional neural network (CNN) model which classifies pixels of an image as hazard tree pixels or as non-hazard tree pixels to perform inference. The model inference module 208 may also generate data structures as outputs of the inference.

The polygon generation module 210 may generate polygons that represent or correspond to hazard trees based on hazard tree pixels classified by the model inference module 208. The polygon attributes module 212 may determine metrics for polygons, such as heights, areas, distances to utility assets, and/or other metrics.

The image transformation module 214 may transform images to generate one or more transformed images. For example, the image transformation module 214 may rotate an image to obtain a rotated image. The model inference module 208 may perform inference on such transformed images to obtain values for the pixels of the images. The image transformation module 214 may undo or reverse the effect of the transformation on the values. For example, where the model inference module 208 performed inference on a transformed image that had been rotated 90 degrees clockwise, the image transformation module 214 may rotate the values 90 degrees counterclockwise.

The location module 216 may map polygons to a georeferenced coordinate system. For example, the location module 216 may perform transformations on polygons using an appropriate projection matrix. The location module 216 may also map assets of electrical utilities.

The potential hazard identification module 218 may determine, based on attributes of polygons, such as heights and distances to electrical assets, whether or not the hazard trees corresponding to the polygons represent potential hazards to the electrical assets. In some embodiments, the potential hazard identification module 218 also determines risks posed to electrical assets by such hazard trees. The potential hazard identification module 218 may determine an amount or extent of a risk and/or a classification of the risk.

In some embodiments, the user interface module 220 may generate user interfaces that include electrical assets and indications of risks to the electrical assets that hazard trees may pose. The notification module 222 may generate notifications of identifications of hazard trees as potential hazards to electrical assets. The notification module 222 may also provide notifications to systems such as the utility systems 106.

In various embodiments, the data storage 224 includes data stored, accessed, and/or modified by any of the modules of the hazard tree identification system 104. The data storage 224 may be or include any data structures, such as tables, lists, databases, and/or any other structures.

A module of the hazard tree identification system 104 may be hardware, software, firmware, or any combination. For example, each module may include functions performed by dedicated hardware (for example, an Application-Specific Integrated Circuit (ASIC), a Field Programmable Gate Array (FPGA), or the like), software, instructions maintained in ROM, and/or any combination. Software may be executed by one or more processors. Although a limited number of modules are depicted in FIG. 2, there may be any number of modules. Further, individual modules may perform any number of functions, including functions of multiple modules as described herein.

FIG. 3A depicts trees at various stages and at various classifications determined by the hazard tree identification system in some embodiments. In one example, a healthy tree 302 may be at a first stage and the hazard tree identification system 104 may classify pixels of an image (for example, a satellite image or an aerial image) of the healthy tree 302 as zero (0), which may refer to non-hazard tree pixels. A first hazard tree 304 may be at a second stage and a second hazard tree 306 may be at a third stage. In this example, the hazard tree identification system 104 may classify at least some pixels of an image of the first hazard tree 304 and at least some pixels of an image of the second hazard tree 306 as one (1), which may refer to hazard tree pixels. It will be appreciated that the hazard tree identification system 104 may utilize other values (for example, values other than zero (0) or one (1)) for classifications of pixels of images of trees. In some embodiments, images may be associated with values between zero and one.

The hazard tree identification system 104 may utilize one or more artificial intelligence (AI) and/or machine learning (ML) models to identify hazard trees from images, such as satellite images with a 30 cm resolution. For example, the hazard tree identification system 104 may utilize one or more convolutional neural networks (CNNs) and/or one or more fully convolutional neural networks (FCNNs) to process images for purposes of identifying hazard trees. A CNN and/or FCNN may be based on a U-Net architecture and may include an encoder and a decoder. In various embodiments, the encoder may be derived from a Resnet50V2 model that has been trained on an ImageNet dataset. In some embodiments, the decoder may include five layers of blocks, and the hazard tree identification system 104 may up-sample the blocks using nearest point interpolation. One advantage of using nearest point interpolation is that it may improve reliability of the CNN and/or FCNN model for images of a wider range of geographic areas. In some embodiments, the hazard tree identification system 104 may up-sample the blocks using transposed convolution.

The hazard tree identification system 104 may utilize one or more generative adversarial networks (GANs) to train the CNN and/or FCNN against adversarial noise and to provide improved generalisability for images of a wider range of geographic areas. The hazard tree identification system 104 may improve the one or more GANs using a combination of a Lovasz-Softmax loss and a cross-entropy loss. One advantage of utilizing a Lovasz-Softmax loss is that it is a tractable surrogate for intersection over union (IoU) measure as compared to a dice loss which corresponds to a per-pixel loss. Since the hazard trees may be small in size on images with 30 cm resolution or lower, IoU loss used in this training strategy may allow the hazard tree identification system 104 to ignore noise in the labelled dataset and at the same time provide inferences that may provide higher quality instance segmentation of hazard trees. In some embodiments, the hazard tree identification system 104 may utilize only a Lovasz-Softmax loss. In one example, a function for cross-entropy loss that the hazard tree identification system 104 may utilize is given by equation (1):

$${L}_{CE} ( y , \hat{y} ) = - {\sum }_{i} {ω}_{i} [ {y}_{i} log {\hat{y}}_{i} + ( 1 - {y}_{i} ) log ( 1 - {\hat{y}}_{i} ) ] \qquad ( 1 )$$

In equation (1), ω may be the weights per pixel, yᵢ may be the ground truth pixel values and ŷᵢ may be the model predictions.

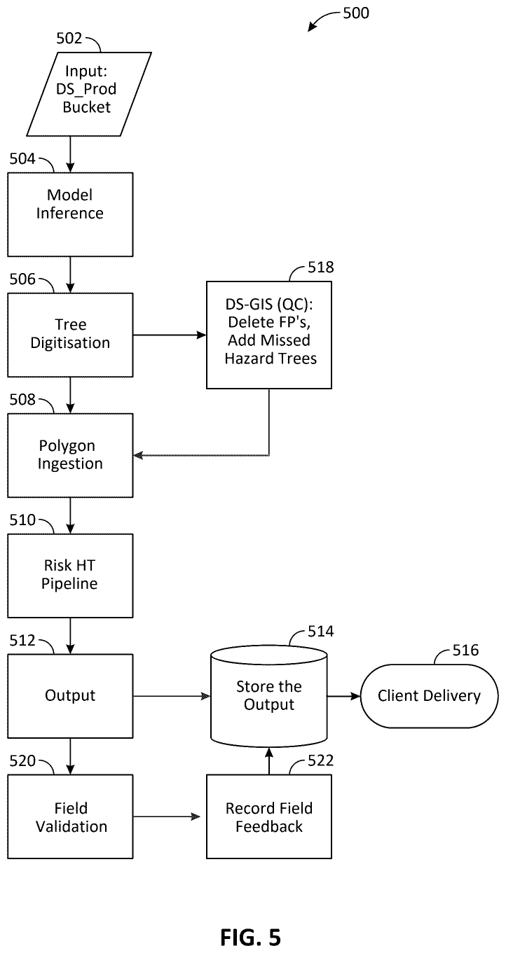

The hazard tree identification system 104 may calculate weights per image to emphasize the edges of the hazard trees that are to be detected via the model. In some embodiments, the hazard tree identification system 104 may calculate the weights by: 1) finding boundaries of polygons using morphological operations to produce another image I and 2) convolving image I with a gaussian kernel which the hazard tree identification system 104 then scales by a constant parameter to produce a weights image W containing weights ωᵢ. FIG. 4A depicts example software code 400 that the hazard tree identification system 104 may utilize to calculate the weights ωᵢ in various embodiments. FIG. 4B depicts example software code 450 that the hazard tree identification system 104 may utilize in calculating a Lovasz-Softmax loss in various embodiments.

In some embodiments, the hazard tree identification system 104 may utilize only a cross-entropy loss. In various embodiments, the hazard tree identification system 104 may, additionally or alternatively, utilize other loss functions.

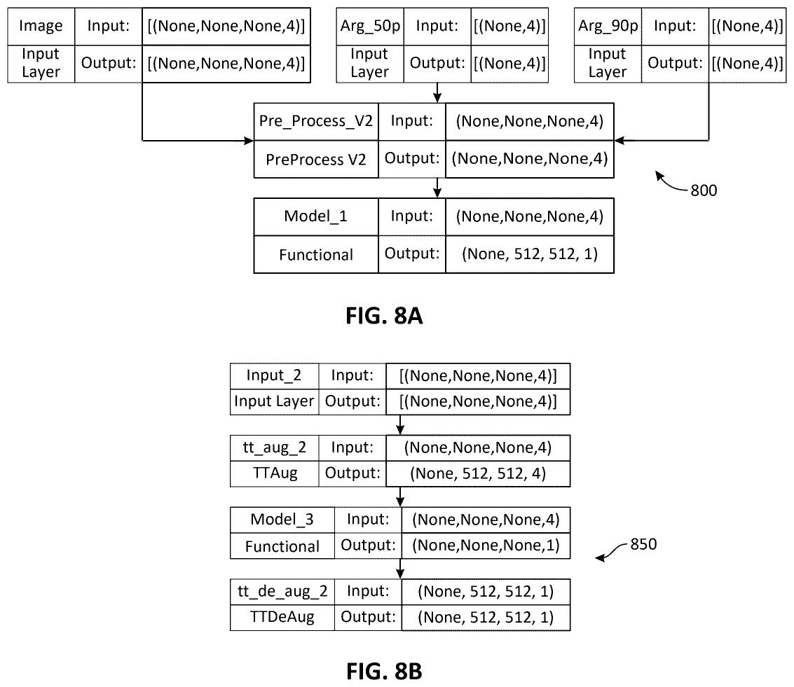

FIG. 5 is a diagram depicting a method 500 for identifying hazard trees in some embodiments. The hazard tree identification system 104 (for example, various modules of the hazard tree identification system 104) may perform the method 500. The method 500 may begin at step 502 where the hazard tree identification system 104 (for example, the image retrieval and processing module 204) receives images for a geographic area. FIG. 7 depicts an example image 700 for a geographic area that may be utilized by the hazard tree identification system 104 in some embodiments. The image 700 includes multiple trees, some of which may be hazard trees. The hazard trees may have characteristics of being dead or unhealthy, such as missing foliage, browned or greyed foliage, greyed limbs or trunks, and/or the like. Such characteristics may be visible, by virtue of their color and/or texture, in images like the image 700.

In some embodiments, the images are images captured by one or more satellites and are georeferenced. Such images may be referred to herein as georeferenced satellite images. A georeferenced satellite image, which may be in the form of a rectangle, may include the coordinates of the top-left vertex and the bottom-right vertex of the rectangle and have a resolution, such as a 30 cm×30 cm spatial resolution. Accordingly, the coordinates of each pixel in the georeferenced satellite image may be determined using the vertex coordinates and the resolution of the georeferenced satellite images.

The georeferenced satellite images may be mono, where a satellite captures one image of a particular area. Alternatively, the georeferenced satellite images may be stereo, where the satellite captures two images of a particular area from two different angles at approximately the same time. The geographic area may include multiple electrical assets of a power distribution infrastructure, such as transmission towers, utility poles, and transmission or distribution lines between utility poles and/or transmission towers (which may be referred to herein as a span).

Returning to FIG. 5, in some embodiments, after receiving the images, the hazard tree identification system 104 (for example, the image retrieval and processing module 204) may process the images for the geographic area. For example, an image may include multiple channels, such as a red channel, a green channel, and a blue channel. Each pixel of the image may have an intensity value for each of the multiple channels. The intensity values may range from zero (0) to 255 or from zero (0) to another value (for example, 4,096) for each channel. The hazard tree identification system 104 may normalize the intensity values of pixels of the image so that, for each pixel, the pixel has an intensity value for each channel of the multiple channels that ranges between zero (0) and one (1).

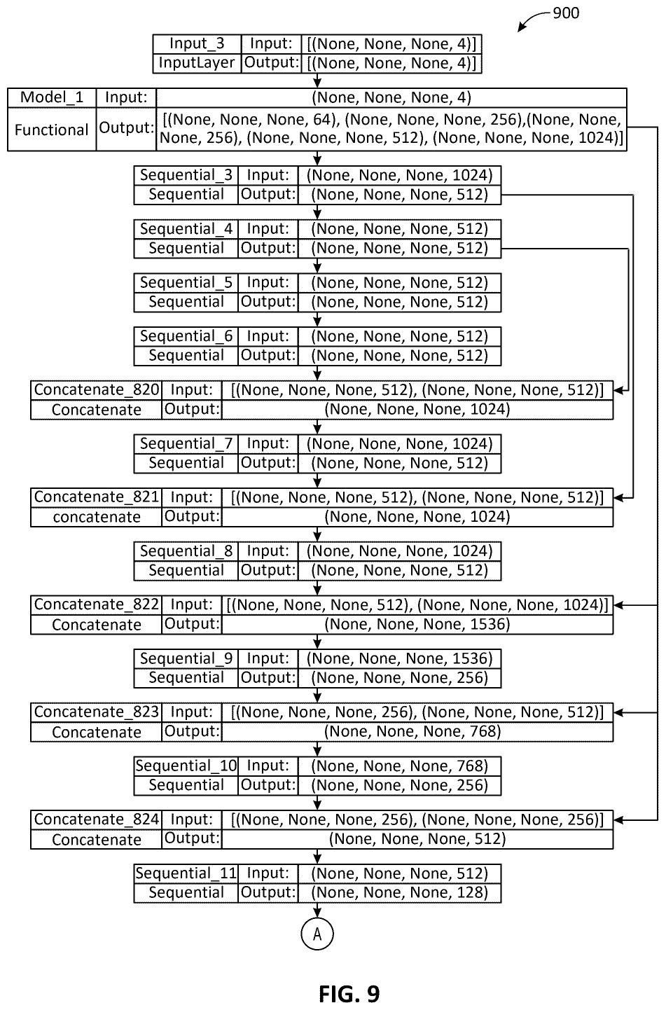

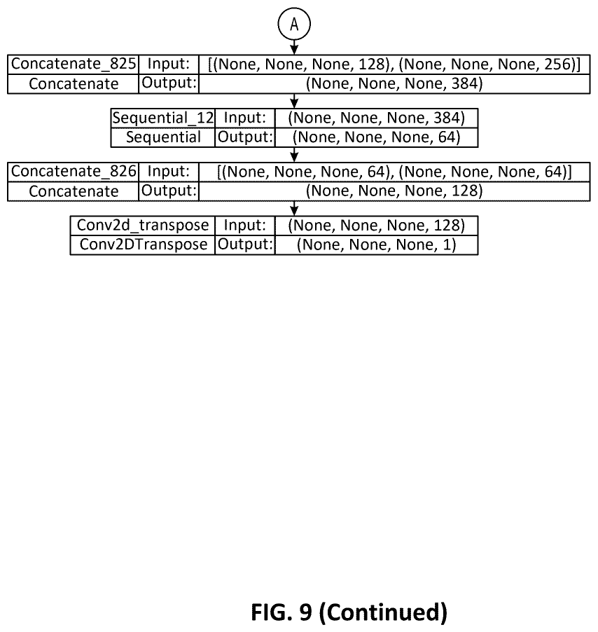

In some embodiments, the hazard tree identification system 104 may process the images for a geographic area by calculating a 50th percentile of intensity values and a 90th percentile of intensity values. The hazard tree identification system 104 may use the 50th percentile of intensity values and the 90th percentile of intensity values that the hazard tree identification system 104 had previously calculated for the multiple images. FIG. 8A depicts an example processing block 800 for processing images according to some embodiments. In the processing block 800 the hazard tree identification system 104 utilizes the 50th percentile of intensity values and the 90th percentile of intensity values. In some embodiments, the processing block 800 may include a TensorFlow optimized layer to batch process images. The hazard tree identification system 104 may have stored the 50th percentile of intensity values and the 90th percentile of intensity values in the data storage 224 and retrieve them from the data storage 224. The hazard tree identification system 104 may process images in other ways, such as by resizing the images, cropping the images, modifying the resolution of images, and/or other ways.

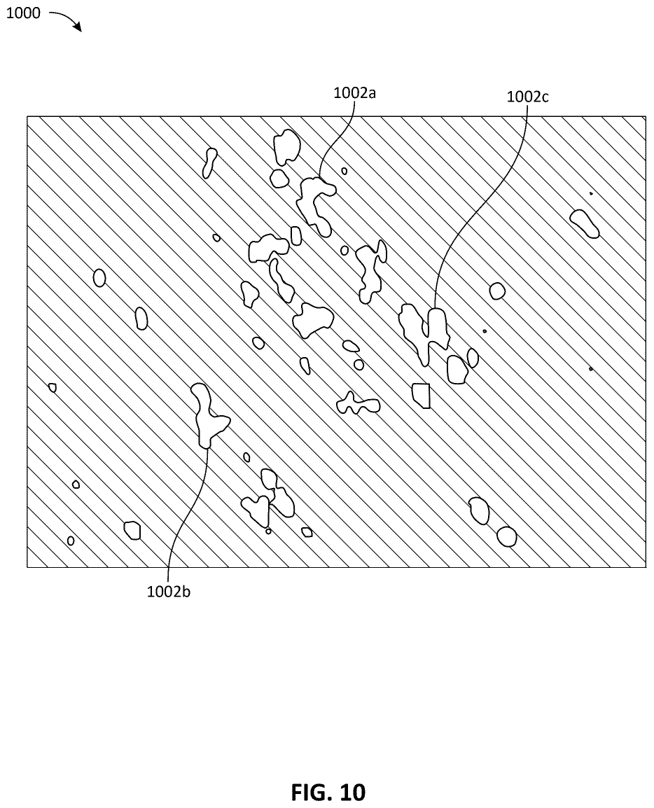

Returning to FIG. 5, at step 504, the hazard tree identification system 104 (for example, the model inference module 208) may perform inference on the images for the geographic area. In some embodiments, the hazard tree identification system 104 classifies, using one or more trained AI and/or ML models (for example, using one or more convolutional neural networks and/or one or more fully convolutional neural networks) the pixels of each image of the multiple images as hazard tree pixels or non-hazard tree pixels. FIG. 9 depicts an example convolutional neural network 900 that the hazard tree identification system 104 may utilize to classify pixels of images in some embodiments. The convolutional neural network 900 may include an encoder and a decoder that is based upon a U-net architecture. The encoder may be derived from a ResNet50V2 model where outputs of intermediate layers are used as the output of the encoders.

In some embodiments, the hazard tree identification system 104 utilizes a test-time augmentation framework to classify pixels of images. FIG. 8B depicts an example test-time augmentation framework 850 that the hazard tree identification system 104 may utilize in some embodiments. The test-time augmentation framework may include an augmentation layer, one or more trained Al and/or ML models (for example, the U-Net encoder and decoder layers of the convolutional neural network 900 of FIG. 9), and a de-augmentation layer. Test-time augmentation may allow for capturing the output of the one or more trained AI and/or ML models under different conditions. In some embodiments, the hazard tree identification system 104 (for example, the image transformation module 214) performs test-time augmentation on an image by performing one or more transformations on the image to generate one or more transformed images, which may be referred to as augmentation. The one or more transformations of the image that the hazard tree identification system 104 may perform on the image may include one or more rotations of the image (for example, 90 degrees clockwise, 90 degrees counter-clockwise, or 180 degrees), one or more flips of the image (for example, about the horizontal axis of the image or about the vertical axis of the image), one or more of resizing the image (for example, to a smaller size and/or a larger size), and one or more additions of noise to the image.

The hazard tree identification system 104 (for example, the model inference module 208) may then process the one or more transformed images and the image using the one or more trained AI and/or ML models to generate one or more first intermediate values for each pixel of the image. The hazard tree identification system 104 (for example, the image transformation module 214) may then modify the one or more first intermediate values so as to undo the effect of the one or more transformations on the image, thereby obtaining one or more second intermediate values. For example, where the hazard tree identification system 104 has rotated an image 90 degrees clockwise, the hazard tree identification system 104 may rotate the second intermediate values 90 degrees counterclockwise. The hazard tree identification system 104 undoing the effect of the one or more transformations may be referred to as de-augmentation. The hazard tree identification system 104 may then apply a statistical function on the one or more second intermediate values to obtain third intermediate values. For example, the hazard tree identification system 104 may average the one or more second intermediate values to obtain the third intermediate values. The hazard tree identification system 104 may then classify each pixel of the image based on the third intermediate values as either a hazard tree pixel or as a non-hazard tree pixel.

One output of the hazard tree identification system 104 classifying pixels of an image using one or more trained AI and/or ML models may include a probability data structure that has dimensions that are sized the same as the dimensions of the image. For example, the probability data structure may have the same number of rows as the width of the image in pixels and the same number of columns as the height of the image in pixels. The probability data structure may include, for each pixel of the image, a probability value that indicates a probability that the pixel is of a portion of a hazard tree. In some embodiments, the probability value may be between zero (0) and one (1). The hazard tree identification system 104 may generate multiple probability data structures by processing the multiple images using the one or more trained AI and/or ML models.

In some embodiments, the hazard tree identification system 104 (for example, the model inference module 208) may generate multiple classification data structures based on the multiple probability data structures. A classification data structure may have dimensions that are sized the same as the dimensions of the image (for example, the classification data structure may have the same number of rows as the width of the image in pixels and the same number of columns as the height of the image in pixels). The hazard tree identification system 104 may generate a classification data structure by iterating through a probability data structure and comparing each probability value to a threshold value (for example, 0.5). If the hazard tree identification system 104 determines that the probability value is equal to or greater than the threshold value, the hazard tree identification system 104 may classify the pixel corresponding to the probability value as a hazard tree pixel. If the hazard tree identification system 104 determines that the probability value is less than the threshold value, the hazard tree identification system 104 may classify the pixel corresponding to the probability value as a non-hazard tree pixel. The hazard tree identification system 104 may generate a classification data structure that includes, for each pixel of the image, the classification of the pixel as a hazard tree pixel or as a non-hazard tree pixel. The hazard tree identification system 104 may generate a classification data structure for each image of the multiple images, thereby generating multiple classification data structures.

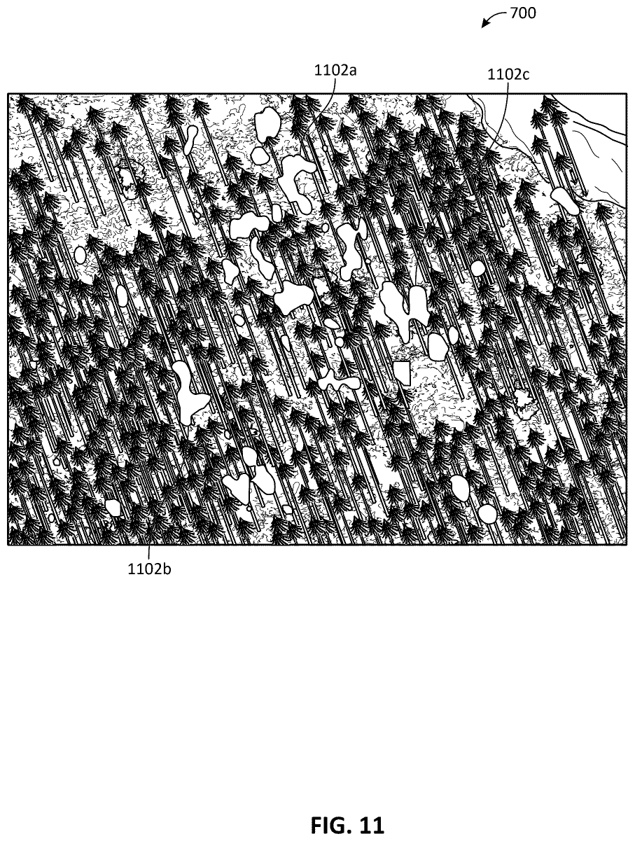

FIG. 10 depicts a representation 1000 of a classification data structure that the hazard tree identification system 104 may have generated based upon processing the image 700 of FIG. 7. The hazard tree identification system 104 may have generated a probability data structure by processing the image 700 using the one or more trained AI and/or ML models. The hazard tree identification system 104 may have generated the classification data structure based upon the probability data structure. The classification data structure corresponds to the image 700 and may include, for each pixel of the image 700, a classification of the pixel as a hazard tree pixel or as a non-hazard tree pixel. The representation 1000 includes multiple collections of hazard tree pixels, such as a first collection 1002a, a second collection 1002b, and a third collection 1002c. Each collection 1002 corresponds to one or more hazard trees in the image 700.

Returning to FIG. 5, the hazard tree identification system 104 may, at step 506, digitize hazard trees using the hazard tree pixels classified in step 504. For example, the hazard tree identification system 104 (for example, the polygon generation module 210) may generate multiple polygons based on the hazard tree pixels, where a polygon corresponds to one or more hazard trees in an image. For a polygon, the hazard tree identification system 104 may identify or determine a set of coordinates that define the polygon. In some embodiments, the hazard tree identification system 104 may utilize morphological operations to find boundaries of a polygon. For example, the hazard tree identification system 104 may remove noisy pixels using morphological operations, which may reduce false positives. U.S. patent application Ser. No. 18/167,830, filed Feb. 10, 2023 and entitled SYSTEMS AND METHODS FOR IDENTIFYING TREES AND ESTIMATING TREE HEIGHTS AND OTHER TREE PARAMETERS, describes techniques for digitizing trees and is incorporated in its entirety by reference herein. The hazard tree identification system 104 (for example, the location module 216) may map the polygons to a georeferenced coordinate system by transforming the geometry of the polygons with an appropriate projection matrix.

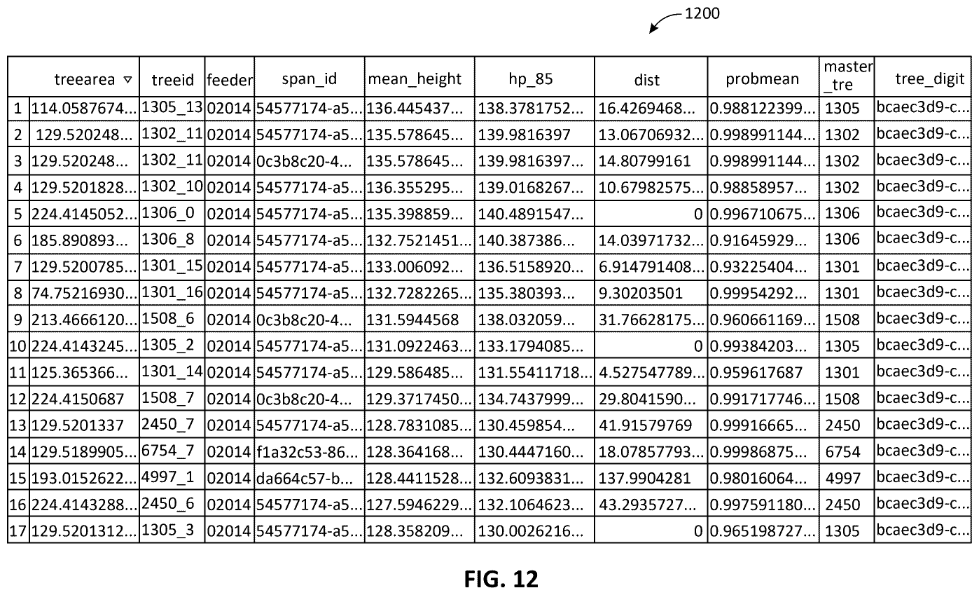

FIG. 11 depicts polygons representing hazard trees superimposed on the image 700 of FIG. 7 that may be generated by the hazard tree identification system 104 in some embodiments. The polygons include a first polygon 1102a, a second polygon 1102b, and a third polygon 1102c. Each of the polygons 1102 corresponds to or represents one or more hazard trees in the image 700. It will be appreciated that the first polygon 1102a corresponds to or represents the first collection 1002a of FIG. 10, and that the second polygon 1102b corresponds to or represents the second collection 1002b and the third polygon 1102c corresponds to or represents the third collection 1002c, both also of FIG. 10. The hazard tree identification system 104 has generated the polygons 1102 based on the collections 1002.

Returning to FIG. 5, also at step 506, the hazard tree identification system 104 (for example, the polygon attributes module 212) may determine or identify metrics for the multiple polygons. For example, for a polygon, the hazard tree identification system 104 may determine a two-dimension area of the polygon using the set of coordinates that define the polygon. The hazard tree identification system 104 may also apply a statistical function to the probabilities of the pixels of the polygon to determine a value. For example, the hazard tree identification system 104 may average the probabilities of the pixels of the polygon to determine an average probability (a mean probability) for the polygon. The hazard tree identification system 104 may also assign one or more unique identifiers to the polygon.

In various embodiments, after the hazard tree identification system 104 has digitized hazard trees, at step 518 one or more quality checks may be performed to remove false positives and correct false negatives. The performance of a quality check may include a person reviewing representations of classification data structures and images received at step 502 in some embodiments. In various embodiments, the hazard tree identification system 104 may perform the quality check by, for example, comparing classification data structures with ground truth determinations of hazard trees to ensure that the numbers or percentages of false positives and the numbers or percentages of false negatives are within appropriate ranges and/or do not meet or exceed appropriate values.

At step 508 the hazard tree identification system 104 (for example, the polygon attributes module 212) may receive the multiple polygons generated at step 506. At step 510 the hazard tree identification system 104 (for example, the polygon attributes module 212) may determine heights of polygons. In some embodiments, the hazard tree identification system 104 may utilize one or more canopy height models (CHMs) to determine the heights of the polygons. The hazard tree identification system 104 may generate the one or more CHMs using the techniques described in the above-referenced U.S. patent application Ser. No. 18/167,830. Additionally or alternatively, the hazard tree identification system 104 may obtain the one or more CHMs from one or more of the image sources 102.

For a polygon corresponding to or representing one or more hazard trees, the hazard tree identification system 104 may utilize the one or more CHMs to determine a height for each pixel of the polygon. The hazard tree identification system 104 may then determine one or more metrics for the polygon based upon the heights of each pixel encompassed by the polygon. For example, the hazard tree identification system 104 may determine an average (mean), a 50th percentile, an 85th percentile, a 90th percentile, a 95th percentile, and/or the like. The hazard tree identification system 104 may assign one or more of the metrics to the polygon as one or more heights of the polygon.

In various embodiments, the hazard tree identification system 104 (for example, the polygon attributes module 212) may filter out polygons whose height do not meet or exceed a height threshold value. The hazard tree identification system 104 may filter out such polygons because the corresponding hazard trees are considered to be not tall enough to be a potential hazard to electrical assets. In some embodiments, the hazard tree identification system 104 does not filter out polygons based on heights.

Also at step 510, for a polygon, the hazard tree identification system 104 (for example, the polygon attributes module 212) may determine one or more distances between the polygon and one or more electrical assets of the power distribution infrastructures. For example, the hazard tree identification system 104 may determine a distance between each pixel of the polygon and each pixel of each electrical asset proximate to the polygon. The hazard tree identification system 104 may utilize bounding boxes around an electrical asset to determine which polygons are proximate to the electrical asset and only determine distances to the electrical asset for those polygons. For example, the hazard tree identification system 104 may utilize bounding boxes that have borders that are approximately 150 feet from the electrical asset to determine which polygons are proximate to the electrical asset. The hazard tree identification system 104 may determine multiple distances from the polygon to an electrical asset.

Also at step 510, the hazard tree identification system 104 (for example, the potential hazard identification module 218) may, for the electrical asset, determine whether or not the one or more hazard trees are a potential hazard to the electrical asset. The hazard tree identification system 104 may utilize a height of the polygon (for example, the mean height of the pixels of the polygon) and a distance from the polygon to the electrical asset (for example, the shortest horizontal distance from the polygon to the electrical asset). The hazard tree identification system 104 may also, for the electrical asset, determine a risk posed to the electrical asset by one or more hazard trees corresponding to or represented by the polygon that the hazard tree identification system 104 has determined is proximate to the electrical asset. For example, the hazard tree identification system 104 may determine an amount of or an extent of the risk that the one or more hazard trees may fall into the electrical asset. In some embodiments, the hazard tree identification system 104 classifies the particular electrical asset as at one of low risk, medium risk, and high risk based on various metrics of the one or more hazard trees.

In various embodiments, the hazard tree identification system 104 may utilize the following method to determine an amount or extent of a risk to an electrical asset posed by a hazard tree. The hazard tree identification system 104 may calculate a radial distance from the tree to the electrical asset using a horizontal distance from the hazard tree to the electrical asset and a height of the hazard tree. The hazard tree identification system 104 may utilize the height of the tallest pixel of the hazard tree as the height of the hazard tree. If the hazard tree identification system 104 determines that the radial distance is smaller than the height of the hazard tree, then the hazard tree identification system 104 may determine that the hazard tree poses a high fall-in risk to the electrical asset. In such a case, the hazard tree identification system 104 classifies the electrical asset as at high risk. An example of a fall-in risk is that the hazard tree may fall into or onto the electrical asset, such as during or after a storm.

If the hazard tree identification system 104 determines that there are no hazard trees whose radial distances are smaller than their heights, the hazard tree identification system 104 may determine that any hazard trees that are still within a predetermined zone surrounding or bounding the electrical asset pose a medium fall-in risk to the electrical asset. In such cases, the hazard tree identification system 104 may classify the electrical asset as at medium risk. For example, the hazard tree identification system 104 may classify a span as at medium risk if there is at least one hazard tree within a 150 foot zone on either side of the span.

If there are no hazard trees within the predetermined zone surrounding or bounding the electrical asset, the hazard tree identification system 104 may classify the electrical asset as at low risk. It should be noted that an electrical asset may have its risk classification changed or modified based on other factors, such as proximity to healthy trees or length in time from last trim cycle.

The hazard tree identification system 104 may utilize one or more heights of the one or more hazard trees, one or more distances to the electrical asset, a number of the one or more hazard trees, and/or other metrics to classify the risk to the electrical asset. For example, the hazard tree identification system 104 may classify the electrical asset as at low risk if there are no hazard trees whose heights are greater than the distances from the hazard trees to the electrical asset. As another example, the hazard tree identification system 104 may classify the electrical asset as at medium risk if there is only one hazard tree whose height is greater than the distance from the hazard tree to the electrical asset. As another example, the hazard tree identification system 104 may classify the electrical asset as at high risk if there is more than one hazard tree whose heights are greater than the distances from the hazard trees to the electrical asset.

In some embodiments, the hazard tree identification system 104 may utilize other metrics as an alternative to or in addition to heights and distances to determine risks and/or classify risks posed by one or more hazard trees to an electrical asset. The various metrics may include an area of a polygon corresponding to one or more hazard trees, a mean probability of the pixels classified as hazard tree pixels of the polygon, and a height of the highest pixel of the polygon. It will be appreciated that the hazard tree identification system 104 may utilize various metrics and/or various methods to determine risks and/or classify risks.

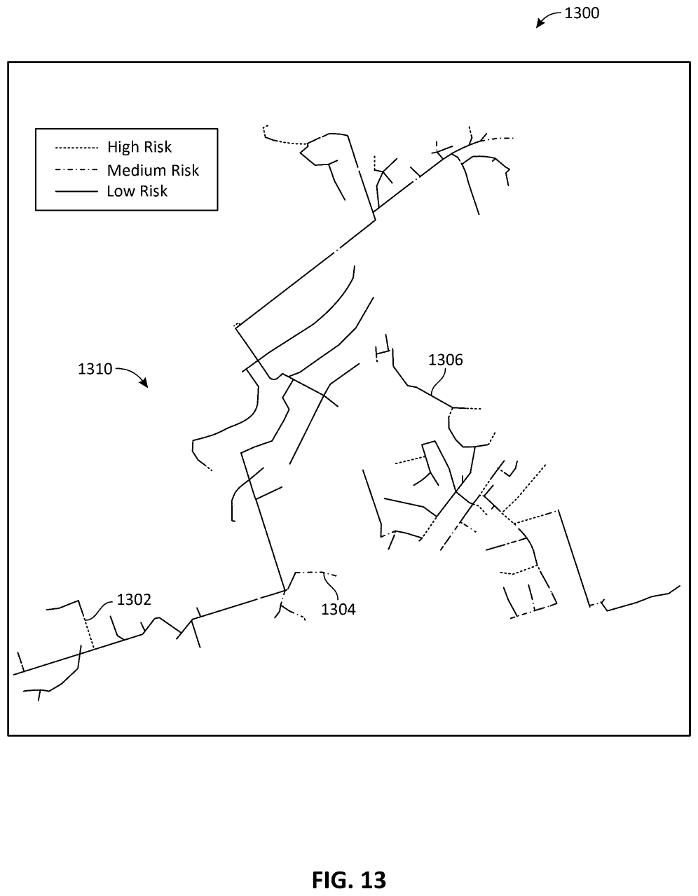

The hazard tree identification system 104 may, at step 512, determine, identify, collect, and/or generate one or more metrics as an output for the hazard trees that the hazard tree identification system 104 has identified. FIG. 12 depicts a table 1200 that the hazard tree identification system 104 has generated in some embodiments. The table 1200 contains metrics for hazard trees that the hazard tree identification system 104 has identified. The metrics may include, for each hazard tree, an area of the hazard tree, a unique identifier of the hazard tree, a unique identifier of a feeder of which an electrical asset is a part, a unique identifier of an electrical asset (for example, a span) to which the hazard tree poses a risk, a mean height of the hazard tree, and an 85th percentile height of the hazard tree. The metrics may also include a distance from the hazard tree to the electrical asset, and a mean probability of the pixels of the hazard tree. The hazard tree identification system 104 may determine, identify, collect, and/or generate one or more metrics other than those disclosed herein for the hazard trees.

Returning to FIG. 5, at step 514, the hazard tree identification system 104 may store the output, such as in the data storage 224. At step 516 the hazard tree identification system 104 (for example, the notification module 222) may generate one or more notifications of the potential hazards posed by one or more hazard trees to one or more electrical assets and provide the one or more notifications. For example, the hazard tree identification system 104 may provide the one or more notifications to a utility system 106. In various embodiments, the hazard tree identification system 104 provides the table 1200 of FIG. 12 as a notification.

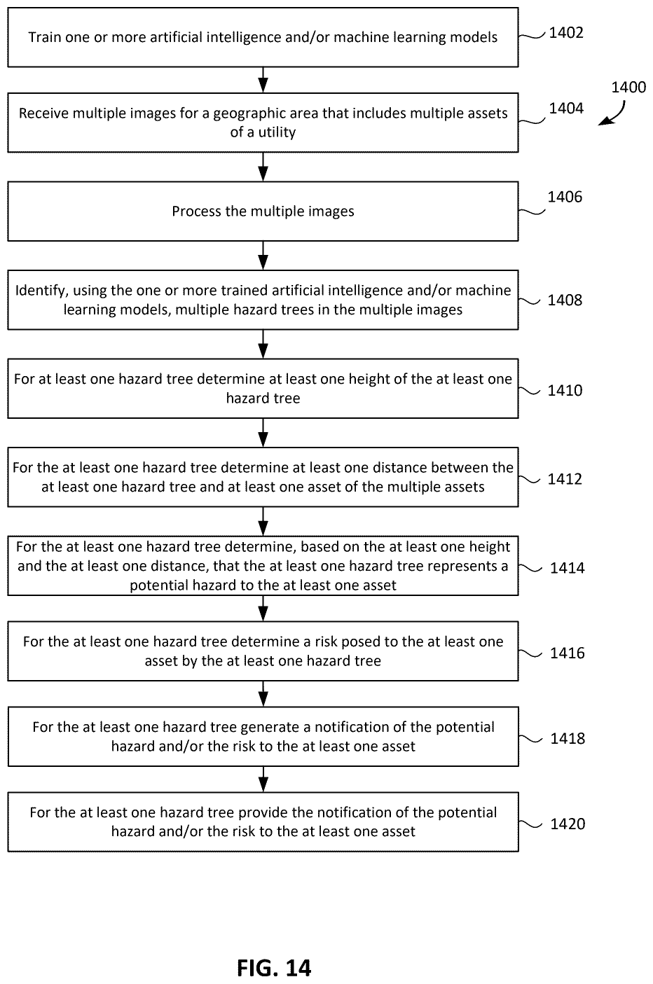

In some embodiments, the hazard tree identification system 104 (for example, the user interface module 220) generates a user interface that includes one or more electrical assets and one or more indications of one or more risks to the one or more electrical assets. FIG. 13 depicts an example user interface 1300 that the hazard tree identification system 104 may generate in some embodiments. The user interface 1300 includes a representation 1310 of a power distribution infrastructure containing multiple electrical assets—spans. The hazard tree identification system 104 has classified the multiple spans according to the risks posed by one or more hazard trees identified by the hazard tree identification system 104. The hazard tree identification system 104 has classified a span 1302 as at high risk from one or more hazard trees proximate to the span 1302. The hazard tree identification system 104 has classified a span 1304 as at medium risk from one or more hazard trees proximate to the span 1304. The hazard tree identification system 104 has classified a span 1306 as at low risk from one or more hazard trees proximate to the span 1306. The hazard tree identification system 104 may color-code the spans according to their classifications. For example, a span may be colored red if it is classified as at high risk, blue if it is classified as at medium risk, and green if it is classified as at low risk.

The hazard tree identification system 104 may provide the user interface 1300 as part of providing a notification of potential hazards to electrical assets. The hazard tree identification system 104 may provide the user interface 1300 in conjunction with a map view that allows for scrolling, zooming, adding, and removing overlays, and other common map view functions. The user interface 1300 may allow a user to select a span. In response to receiving a selection of a span, the hazard tree identification system 104 may show the one or more hazard trees that represent a potential hazard to the selected span and details about the one or more hazard trees, such as height, area, species, volume, or other metrics. The hazard tree identification system 104 may also provide information about when the vegetation management operations were last performed about the selected span. In some embodiments, the hazard tree identification system 104 may allow a user to commence and submit a work order for vegetation management operations for the selected span. In various embodiments, the hazard tree identification system 104 may automatically submit work orders for trimming operations for high-risk spans or other high-risk electrical assets.

In some embodiments, the hazard tree identification system 104 may generate a shapefile that includes identifications of hazard trees, detection probabilities, heights, and/or other metrics. The hazard tree identification system 104 may provide the shapefile to the utility system 106 so that the shapefile may be used by Geographic Information System (GIS) programs that the utility operating the utility system 106 utilizes.

Returning to FIG. 5, in various embodiments, field validation of the identification of hazard trees by the hazard tree identification system 104 may be performed at step 520. For example, an employee of a utility may confirm in the field that a tree identified as a hazard by the hazard tree identification system 104 is indeed a hazard and that it poses a risk to an electrical asset. The field validation may be recorded at step 522 and the hazard tree identification system 104 may store the field validation at step 514 in, for example, the data storage 224. The hazard tree identification system 104 may utilize the field validation to assist in future training of the one or more Al and/or ML models. One advantage of utilizing field validations may be in the reduction of future false positives and/or false negatives by the hazard tree identification system 104.

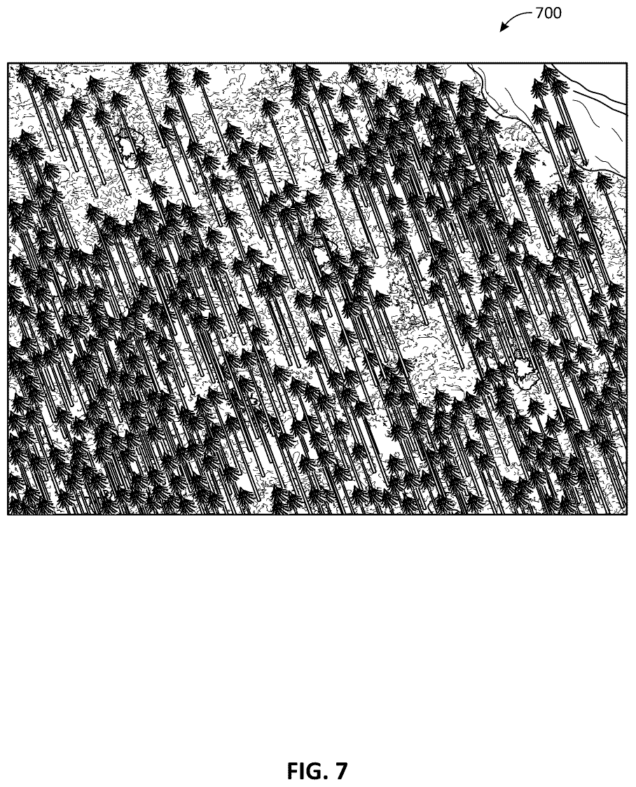

FIG. 6 is a diagram depicting a method 600 for identifying hazard trees in some embodiments. The hazard tree identification system 104 (for example, various modules of the hazard tree identification system 104) may perform the method 600. The method 600 may begin at step 602 where the hazard tree identification system 104 (for example, the image retrieval and processing module 204) receives images for a geographic area. The hazard tree identification system 104 may process the images as described in step 502 of the method 500, or the images may have already been processed as described in step 502 of the method 500, such as by a different system. At step 604 the hazard tree identification system 104 (for example, the model inference module 208) may perform inference using the images received in step 602. At step 606 the hazard tree identification system 104 may generate a representation of a classification data structure.

At step 608 the hazard tree identification system 104 may digitize hazard trees using the classification data structure. The hazard tree identification system 104 may generate a shapefile that includes polygons representing hazard trees and probability attributes for the polygons. The shapefile may encompass all or a portion of the geographic area for the images received in step 602. At step 610 the hazard tree identification system 104 may assign heights to hazard trees using one or more canopy height models 612. Also at step 610 the hazard tree identification system 104 may determine distances between hazard trees and electrical assets. The hazard tree identification system 104 may also determine whether or not hazard trees represent potential hazards to the electrical assets based on the heights and distances. In some embodiments, the hazard tree identification system 104 may also, at step 610, determine risks posed to the electrical assets by the hazard trees.

At step 614 the hazard tree identification system 104 may generate and provide an output. In various embodiments, the output includes a shapefile with identifications of hazard trees, detection probabilities, heights, and/or other metrics. In some embodiments, the hazard tree identification system 104 may generate a table similar to the table 1200 depicted in FIG. 12 and/or a user interface similar to the user interface 1300 depicted in FIG. 13 as the output. The hazard tree identification system 104 may provide the output to, for example, a utility system 106.

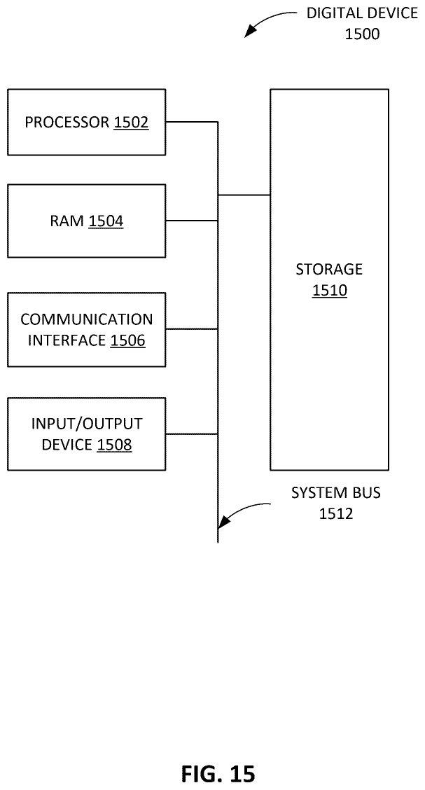

FIG. 14 is a flow diagram depicting a method 1400 for identifying hazard trees in some embodiments. The hazard tree identification system 104 (for example, various modules of the hazard tree identification system 104) may perform the method 1400. The method 1400 may begin at step 1402 where the hazard tree identification system 104 (for example, the model training module 206) may train one or more artificial intelligence and/or machine learning models. For example, the hazard tree identification system 104 may train one or more fully convolutional neural networks and/or convolutional neural networks as described herein.

At step 1404 the hazard tree identification system 104 (for example, the image retrieval and processing module 204) receives multiple images for a geographic area that includes multiple assets of a utility, such as multiple electrical assets (for example, spans) of an electrical power utility. At step 1406 the hazard tree identification system 104 (for example, the image retrieval and processing module 204) may process the multiple images. For example, the hazard tree identification system 104 may normalize the intensity values of each pixel of each image of the multiple images (for example, to be a value between zero (0) and one (1)). The hazard tree identification system 104 may process the multiple images using other techniques, such as those described herein.

At step 1408 the hazard tree identification system 104 (for example, the model inference module 208) identifies, using the one or more trained artificial intelligence and/or machine learning models, multiple hazard trees in the multiple images. The hazard tree identification system 104 may identify hazard trees using the techniques described herein (for example, classifying pixels of images as hazard tree pixels or as non-hazard tree pixels and digitizing hazard trees based on the hazard tree pixels).

The hazard tree identification system 104 (for example, the polygon attributes module 212) may, at step 1410, for at least one hazard tree of the multiple hazard trees, determine at least one height of the at least one hazard tree. For example, the hazard tree identification system 104 may use one or more canopy height models (CHMs) to determine the at least one height of the at least one hazard tree. At step 1412 the hazard tree identification system 104 (for example, the polygon attributes module 212) may, for the at least one hazard tree, determine at least one distance between the at least one hazard tree and at least one asset of the multiple assets. The hazard tree identification system 104 may determine the at least one distance as described herein.

At step 1414 the hazard tree identification system 104 (for example, the potential hazard identification module 218) may, for the at least one hazard tree, determine, based on the at least one height and the at least one distance, that the at least one hazard tree represents a potential hazard to the at least one asset. At step 1416 the hazard tree identification system 104 (for example, the potential hazard identification module 218) may, for the at least one hazard tree, determine a risk posed to the at least one asset by the at least one hazard tree. The hazard tree identification system 104 may determine the potential hazard and/or the risk as described herein.

At step 1418 the hazard tree identification system 104 (for example, the notification module 222) may, for the at least one hazard tree, generate a notification of the potential hazard and/or the risk to the at least one asset. At step 1420 the hazard tree identification system 104 (for example, the notification module 222) may, for the at least one hazard tree, provide the notification of the potential hazard and/or the risk to the at least one asset. The hazard tree identification system 104 may generate and provide the notification as described herein.

One advantage of embodiments of the hazard tree identification system 104 and associated methods and non-transitory computer-readable media is that the hazard tree identification system 104 is able to predict patterns of hazard trees across large numbers of images that include electrical assets. Another advantage is that the hazard tree identification system 104 may minimize or reduce the amount of manual work that would otherwise be done to detect hazard trees. Images such as satellite images may be acquired frequently. The hazard tree identification system 104 may process such images as they are acquired and identify new hazard trees and/or stop tracking hazard trees as they are removed. Accordingly, the hazard tree identification system 104 may facilitate monitoring of a power distribution infrastructure on a periodic and/or as-needed basis.

FIG. 15 depicts a block diagram of an example digital device 1500 according to some embodiments. The digital device 1500 is shown in the form of a general-purpose computing device. The digital device 1500 includes at least one processor 1502, RAM 1504, communication interface 1506, input/output device 1508, storage 1510, and a system bus 1512 that couples various system components including storage 1510 to the at least one processor 1502. A system, such as a computing system, may be or include one or more of the digital device 1500.

System bus 1512 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

The digital device 1500 typically includes a variety of computer system readable media, such as computer system readable storage media. Such media may be any available media that is accessible by any of the systems described herein and it includes both volatile and nonvolatile media, removable and non-removable media.

In some embodiments, the at least one processor 1502 is configured to execute executable instructions (for example, programs). In some embodiments, the at least one processor 1502 comprises circuitry or any processor capable of processing the executable instructions.

In some embodiments, RAM 1504 stores programs and/or data. In various embodiments, working data is stored within RAM 1504. The data within RAM 1504 may be cleared or ultimately transferred to storage 1510, such as prior to reset and/or powering down the digital device 1500.

In some embodiments, the digital device 1500 is coupled to a network, such as the communication network 108, via communication interface 1506. The digital device 1500 can communicate with one or more networks such as a local area network (LAN), a general wide area network (WAN), and/or a public network (for example, the Internet).

In some embodiments, input/output device 1508 is any device that inputs data (for example, mouse, keyboard, stylus, sensors, etc.) or outputs data (for example, speaker, display, virtual reality headset).

In some embodiments, storage 1510 can include computer system readable media in the form of non-volatile memory, such as read only memory (ROM), programmable read only memory (PROM), solid-state drives (SSD), flash memory, and/or cache memory. Storage 1510 may further include other removable/non-removable, volatile/non-volatile computer system storage media. By way of example only, storage 1510 can be provided for reading from and writing to a non-removable, non-volatile magnetic media. The storage 1510 may include a non-transitory computer-readable medium, or multiple non-transitory computer-readable media, which stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1512 by one or more data media interfaces. As will be further depicted and described below, storage 1510 may include at least one program product having a set (for example, at least one) of program modules that are configured to carry out the functions of embodiments of the invention. In some embodiments, RAM 1504 is found within storage 1510.

Programs/utilities, having a set (at least one) of program modules, such as the hazard tree identification system 104, may be stored in storage 1510 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with the digital device 1500. Examples include, but are not limited to microcode, device drivers, redundant processing units, and external disk drive arrays, RAID systems, tape drives, and data archival storage systems, etc.

With the technological advancements, we can measure various forest biophysical parameters with the help of satellite remote sensing, which may be used to model carbon stored in the tree/forest. At least some embodiments described herein identify tree stumps (e.g., each or a plurality) across an area (e.g., woodland), measure the elevation of at least a plurality of the identified tree stumps, and, as a result, define the estimated number of trees in the woodland (e.g., above 1.5 m)

Samples and measurements may be cross referenced to the models to validate the georeferenced position, modelled measurements, and to label the tree species. The tree species samples may act as a calibration within the ML model may be used to refine the model species assignment across the Strata. Accordingly, the model can assign each tree in the model with a tree species identifier based on the optical properties in the satellite image and sample references.

In various embodiments, trees (e.g., all trees) are labelled with associated measurements and each tree Carbon/biomass is calculated in the Strata. This replaces the extrapolation process and provides a more robust and accurate method for assessment.

In various embodiments, remote sensing data, such as satellite images, are used to measure and/or estimate multiple aspects of trees and forests that are traditionally measured on the ground. In some embodiments, a system employs multiple models to process the remote sensing data and calculate biomass and carbon sequestration with improved accuracy and efficiency compared to traditional methods.

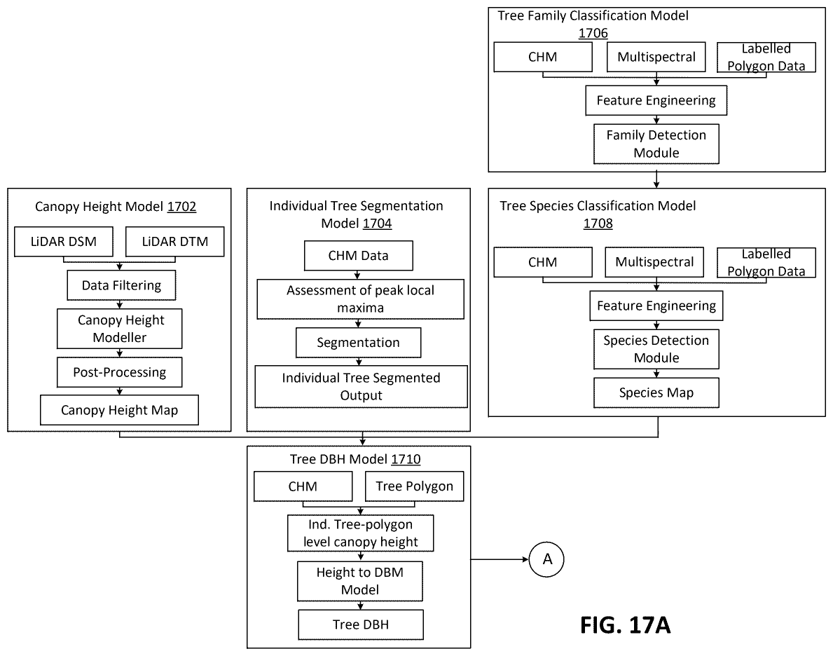

FIG. 16 illustrates a block diagram of a carbon dioxide estimation system 1600 in some embodiments. The carbon dioxide estimation system 1600 includes multiple interconnected modules arranged in a structured layout for processing and analyzing woodland carbon data.

FIG. 1 depicts an example environment 100 in which the carbon dioxide estimation system 1600 (in addition to or in place of a hazard tree identification system) may operate in some embodiments. As discussed herein, the environment 100 includes multiple image sources 102A through 102N (which may be referred to as an image source 102 or as image sources 102), multiple utility systems 106A through 106N (which may be referred to as a utility system 106 or as utility systems 106) and a communication network 108. Each of the image sources 102, the carbon dioxide estimation system 1600, and the utility systems 106 may be or include any number of digital devices. A digital device is any device with at least one processor and memory.

In some embodiments, the carbon dioxide estimation system 1600 may include or be in addition to the hazard tree identification system 104 discussed herein. For example, the carbon dioxide estimation system 1600 may include any number of modules and perform any number of functions of the hazard tree identification system 104. In some embodiments, the carbon dioxide estimation system 1600 may communicate with the hazard tree identification system 104 over the communication network 108 (e.g., sharing images, classifications, AI models (e.g., convolutional neural networks and/or ensemble networks), and/or the like.

As discussed herein, Image sources 102A to 102N may each be a third-party system configured to provide images or access to images. Different third parties may periodically capture images of geographic areas. For example, some third parties may obtain images (e.g., multispectral data and/or spectral signatures) of geographic areas from satellites, airplanes, helicopters, and/or drones at regular intervals or on-demand for a variety of purposes. Satellite images are images of Earth collected by imaging satellites operated by governments and businesses. Different third parties may obtain images from different sources (for example, different satellites, airplanes, helicopters, drones, or the like) for the same and/or different geographic regions. An example of a third party that captures, collects, and/or provides images covering geographic regions is Airbus. The third parties may provide images and/or license access to the images to other businesses for a variety of purposes (e.g., via one or more image sources 102A-102N).

As discussed with regard to FIG. 1, in some embodiments, any number of the image sources 102A-N may obtain images of the same geographic area (e.g., from satellites, aircraft, and/or drones) and save them over time. As such, an image source 102A may obtain and store images of the same geographic site taken on different days, months, or years. For example, an image source 102A may provide images at a first duration of time (for example, taken at a particular time and date). The image source 102A may also provide images of the same geographic areas for a second duration (for example, taken at a different particular time or date, such as one or more years before or after the first duration). The image source(s) 102A-N may provide the images to the to the carbon dioxide estimation system 1600.

Any number of the image sources 102A-N may provide application programming interfaces (APIs) to enable another system (for example, the to the carbon dioxide estimation system 1600) to request images for a particular geographic area (for example, all or part of a geographic region). The request may be or include a request for current images and/or for images of the same geographic areas taken at different times. In various embodiments, the carbon dioxide estimation system 1600 may request information on what geographic area images are available and at what time frames (e.g., the tree segmentation module 1606 and/or the canopy height module 1604 may request or retrieve images and/or multispectral information via the communication module 1602). A geographic area (e.g., woodland area) may be any portion of the surface of the earth. In various embodiments described herein, a geographic area includes assets. For example, electrical assets of a power distribution infrastructure, alternatively referred to as an electrical network infrastructure, may be in a geographic area.

The carbon dioxide estimation system 1600 may be configured to receive images of any number of geographic areas. The carbon dioxide estimation system 1600 may utilize the images to identify trees (e.g., family and/or species by the tree family classification module 1608 and/or the tree species classification module 1610), determine a canopy height (e.g., by the canopy height module 1604), identify tree segments in the image (e.g., by the tree segmentation module 1606), and calculate a diameter to breast height (DBH) (e.g. by the tree DBH module 1612) to determine tree tariff numbers (e.g., by the tree species tariff module 1614), tree volume (e.g., by the tree volume module 1616), trunk biomass (e.g., by the biomass module 1618), and estimate CO2 equivalent stored in the geographic area (e.g., by the carbon dioxide estimation module 1620). In some embodiments, the carbon dioxide estimation system 1600 may receive images over time and take into account improvements that may impact carbon dioxide estimation which may assist in determining changes (e.g., positive or negative) in carbon dioxide storage in the particular natural environment that may be related to those improvements.

In various embodiments, the carbon dioxide estimation system 1600 may enhance, orient, and analyze (for example, using artificial intelligence (AI) and/or machine learning (ML) systems) geographic images to identify trees and/or vegetation in the images. In some embodiments, the carbon dioxide estimation system 1600 may estimate the heights of trees, their crown areas, their volumes, and/or their densities. The carbon dioxide estimation system 1600 may plot the vegetation (such as trees) on maps and/or provide shapefiles that include information regarding vegetation, such as the location, shape, and attributes of vegetation. Such shapefiles may be utilized in Geographic Information System (GIS) software.

In various embodiments, the carbon dioxide estimation system 1600 may request current satellite images from third parties, such as businesses or governments that operate imaging satellites, and utilize the images to identify trees. The carbon dioxide estimation system 1600 may request other satellite, airplane, helicopter, and/or drone images for the same geographic areas from the same and/or different image sources (e.g., image sources 102A-102N), combine the images from different image sources for the same geographic areas and then analyze the information to identify changes to carbon dioxide associated with the geographic area.

Utilizing satellite, airplane, helicopter, and/or drone images provides significant advantages over manual viewing from the ground. For example, in addition to case in obtaining the images, it will be appreciated that satellite images may have sufficient spatial resolution (e.g., 30 centimeters (cm)×30 cm) for evaluating vegetation such as trees. The spatial resolution may refer to the size of a geographic area on the Earth represented by one pixel of the satellite image. For example, a 30 cm×30 cm spatial resolution may mean each pixel of the satellite image represents a 900 square centimeter area.

Different aerial or satellite images may have different spatial resolutions. In one example, a set of satellite images has a spatial resolution of 50 cm×50 cm. In some embodiments, satellite images have spatial resolutions other than 30 cm×30 cm and 50 cm×50 cm. The hazard tree identification system 104 may utilize satellite images that have spatial resolutions ranging from approximately 5 cm×5 cm to approximately 50 cm×50 cm. Due to cost constraints and/or image availability, the hazard tree identification system 104 may receive images of the same area with different spatial resolutions. The hazard tree identification system 104 may modify certain satellite images to conform to a standard resolution.

In some embodiments, the carbon dioxide estimation system 1600 may utilize artificial intelligence and/or machine learning, such as a trained convolutional neural network (CNN), to improve the quality of captured images using histogram modification, contrast enhancement, and/or bilinear interpolation to generate high-resolution images from low-resolution images. U.S. patent application Ser. No. 17/160,231 filed on Jan. 27, 2021, and entitled “SYSTEM AND METHOD OF INTELLIGENT VEGETATION MANAGEMENT,” describes such utilization of artificial intelligence and/or machine learning and is incorporated in its entirety herein by reference.

Satellite images may be captured using red-green-blue (RGB) bands as well as an infrared (IR) band. The cost of satellite imagery may be high. Accordingly, images captured using other image capture forms may be considered. In some terrains, such as residential areas with many mature trees obscuring transmission lines, a spatial resolution lower than 30 cm×30 cm may be insufficient. The cost of satellite imagery may make this imagery solution too expensive and prohibitive. To obtain images of terrains with a spatial resolution of higher than 30 cm×30 cm may require other forms of image capture, such as drones. Drones, however, may have a limited flight time, and therefore, the area of the physical environment captured by drones may be less than that of a satellite.

Images may also be captured using an airplane, sometimes referred to as aviation photography, or by a helicopter, a drone, or other airborne vehicle. Similar to satellite images, images captured using airplanes, helicopters, drones, and the like (generally referred to as aerial images) may be licensed or captured on-demand by private companies. Aerial images may have a higher spatial resolution than satellite images and may provide another source of digital images for the carbon dioxide estimation system 1600.

To account for the differences in image capture angles resulting from different forms of image capture, such as satellites, airplanes, helicopters, and drones, the hazard tree identification system 104 may receive images of the same area captured by different image capture methods. In some embodiments, the carbon dioxide estimation system 1600 may utilize images from different methods of image capture to correct for different image capture angles, enhance the information contained within the images, and add information for more accurate analysis. The carbon dioxide estimation system 1600 may utilize artificial intelligence and/or machine learning algorithms or models to correct the image capture angles, which may distort objects captured in the images.

In various embodiments, due to environmental factors such as cloud coverage, smoke, or fog, a satellite may require more than one flyover to capture satellite images, or an airplane, helicopter and/or drone may require more than one pass to capture aerial images of a particular area. The carbon dioxide estimation system 1600 may utilize artificial intelligence and/or machine learning algorithms or models to recognize features on each of the multiple images of the particular area. Similarly, the carbon dioxide estimation system 1600 may utilize artificial intelligence and/or machine learning algorithms or models, such as a CNN, to improve the quality of captured images by using contrast enhancement. In some embodiments, the carbon dioxide estimation system 1600 may receive satellite imagery of the same area over several years and use that information to estimate the growth of trees in that area and generate an estimate of a future schedule of estimating carbon dioxide.

In some embodiments, the communication network 108 may represent one or more computer networks (for example, LAN, WAN, and/or the like). The communication network 108 may provide communication between any of the image sources 102, the hazard tree identification system 104, and any of the utility systems 106. In some implementations, the communication network 108 comprises computer devices, routers, cables, and/or other network topologies. In some embodiments, the communication network 108 may be wired and/or wireless. In various embodiments, the communication network 108 may comprise the Internet, one or more networks that may be public, private, IP-based, non-IP based, and so forth.

The carbon dioxide estimation system 1600 may comprise a communication module 1602, a canopy height module 1604, a tree segmentation module 1606, a tree family classification module 1608, tree species classification module 1610, a tree DBH module 1612, a tree species tariff module 1614, a tree volume module 1616, a biomass module 1618, a carbon dioxide estimation module 1620, a notification module 1622, and a data storage 1624.

The communication module 1602, similar to the communication module 202, may send and receive requests or data between any of the image sources 102, the carbon dioxide estimation system 1600, and any other system. The communication module 1602 may receive a request from a user of the hazard tree identification system 104 (for example, via an interface) to request images from the image source 102. In some embodiments, the communication module 202 may provide an interface or information for a remote interface to enable a third party (for example, a utility, a vegetation management company, workers, supervisors, contractors, insurance companies, and/or the like) to view and manage vegetation and other safety activities.

In some embodiments, the canopy height module 1604 receives digital surface models of the geographic region and generates canopy height models from the digital surface models. In some embodiments, the canopy height models include the heights of every pixel of the images of the geographic region. The canopy height module 1604 may associate heights of pixels from the canopy height models with the polygons of vectors and store the associated data in the data storage 1624.

The canopy height module 1604 or the tree segmentation module 1606 may receive digital surface models of the geographic region. In some embodiments, the canopy height module 1604 or the tree segmentation module 1606 receives a set of georeferenced stereo satellite images of a geographic region. The canopy height module 1604 or the tree segmentation module 1606 may use the georeferenced stereo satellite images to produce disparity maps, and use the disparity maps to generate digital surface models. In other embodiments, the digital canopy height module 1604 or the tree segmentation module 1606 receives digital surface models that have been generated by a third-party system. In such embodiments, the digital surface model module 212 may not necessarily need to receive georeferenced stereo satellite images. In some embodiments, the digital surface model module 212 receives digital surface models for a first portion of the geographic region and generates digital surface models for a second portion of the geographic region from georeferenced stereo satellite images.

A digital surface model is a raster. For digital surface models, in general, a pixel is either an object pixel (such as a tree, a building, a vehicle, or other obstruction) or a ground pixel. Digital surface models include heights of pixels, and ground elevation and object heights are given in terms of difference from mean sea level (MSL). That is, a digital surface model gives the height of an object as the sum of the elevation of the ground and the height of the object on the ground. For example, for a tree at a ground elevation of 200 m having a height of 10 m, the digital surface model would give the tree height as 210 m.

In some embodiments, the canopy height module 1604 generates canopy height models. A canopy height model or canopy height map (e.g., CHM) may be created from a digital surface model (DSM) and a digital terrain model (DTM). A digital terrain model gives the ground elevation, without the height of objects on the ground, in terms of difference with MSL. One technical problem is that digital surface models and digital terrain models may not be calibrated in the same way. Using digital surface models and digital terrain models that are not calibrated in the same way may not produce accurate results. This is because a digital surface model calibrated according to one technique may give different ground elevations and heights for objects than a digital surface model calibrated according to a different technique. Therefore, using a digital terrain model to derive a digital surface model calibrated one way and another digital surface model calibrated another way to calculate a canopy height model may not give ground elevations and object heights that meet a required level of accuracy (that is, outside of a prescribed acceptable error range). Typically, different third-parties use different calibration techniques in generating their digital surface models, but even digital surface models and digital terrain models produced by the same third-party may not be calibrated the same way and thus may not be usable to generate canopy height models to a required degree of accuracy. Accordingly, it may be difficult to generate a canopy height model that provides elevations to a prescribed accuracy (for example +/−approximately 2-3 feet).

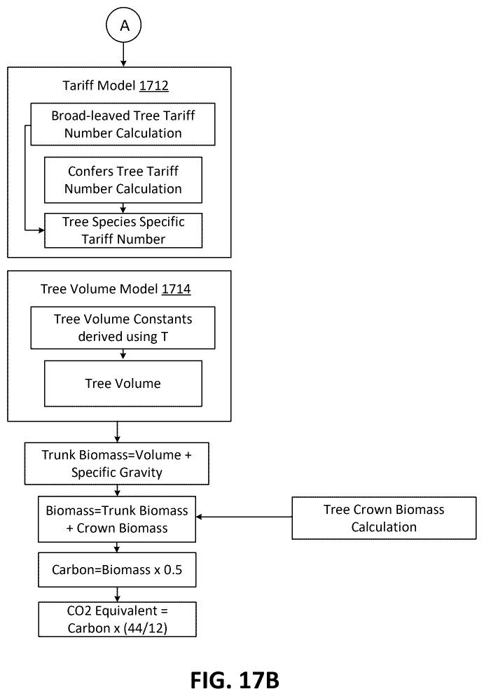

Using the DSM and DTM, the canopy height module 1604 may generate a canopy height model and then apply the model to generate a canopy height map as shown with regard to the canopy height model 1702 shown in FIG. 17A.

As discussed herein, the canopy height module 1604 may receive remote sensing data of a geographic area (e.g., a natural environment such as a woodland or the like). The remote sensing data may include a DSM and/or DTM. In some embodiments, the remote sensing data includes images, video, RGB, LiDAR, spectral fingerprints, and/or the like. In some embodiments, the tree segmentation module 1606 identifies individual trees and/or groups of trees by combining optical and/or LiDAR data to determine boundaries of individual and/or groups of trees. In some embodiments, the carbon dioxide estimation system 1600 stratifies the geographic area into homogeneous regions based on tree characteristics and calculates carbon sequestration for each of the homogeneous regions. In some embodiments, the carbon dioxide estimation system 1600 may combine carbon sequestration values for the homogeneous regions to determine total carbon sequestration for the geographic area.

In some embodiments, the canopy height module 1604 applies minimum pooling operations to one or more previously received digital surface models, thereby obtaining initial digital terrain models. The canopy height module 1604 may calculate a peak signal to noise ratio (a calculated peak signal to noise ratio, a calculated PSNR) of the initial digital terrain models to the digital surface models. The canopy height module 1604 may then compare the calculated PSNR to a predetermined first threshold. If the PSNR is still greater than the predetermined first threshold (does not exceed the predetermined first threshold).

If the PSNR is less than the predetermined first threshold, the canopy height module 1604 then generates initial canopy height models by subtracting the initial digital terrain models from the digital surface models. The canopy height module 1604 may determine first pixels in the initial canopy height models that have heights greater than a predetermined second threshold, such as a threshold that is approximately 1.5 m to approximately 2.0 m. It will be appreciated that the thresholds may be any value.

At the first pixels in the initial canopy height models, there may be an object, such as a tree, a building, vehicle, or other obstruction. Accordingly, the first pixels may be referred to as object pixels. The heights of the first pixels in the digital surface models are the sum of the elevation of the ground and the height of an object on the ground from MSL.

The canopy height module 1604 may then determine second pixels in the one or more initial digital terrain models that correspond to the first pixels. The canopy height module 1604 may replace heights of the second pixels with null values. The canopy height module 1604 may determine third pixels surrounding the second pixels in the one or more initial digital terrain models. The third pixels may be pixels surrounding the object pixels that have heights less than the predetermined second threshold of approximately 1.5 m to approximately 2.0 m. Accordingly, the third pixels may be referred to as ground pixels. The canopy height module 1604 may generate one or more final digital terrain models by interpolating heights from the heights of the third pixels, and replacing the heights of the second pixels with the interpolated heights. The canopy height module 1604 may generate the canopy height models of the geographic region by subtracting the final digital terrain models from the digital surface models. Although the process discussed above refers to pixels, it will be appreciated that any portion or unit of an image may be used.

Accordingly, this process provides a technical solution to the foregoing technical problem of obtaining canopy height models that provide elevations to a desired degree of accuracy. One advantage of this process is that the digital terrain models are calibrated in the same way as the digital surface models, thereby ensuring more accurate heights in the canopy height models. Another advantage is that because the canopy height module 1604 generates the digital terrain models, the need to obtain digital terrain models from a third party is obviated.

In various embodiments, the canopy height models generated by the canopy height module 1604 are or utilizes rasters in which every pixel has coordinates and a height value. The canopy height module 1604 may associate one or more heights of pixels from the canopy height models with the polygons of vectors and store the associated data in the data storage 1624. This allows for the canopy height module 1604 to associate every polygon with one or more heights. In some embodiments, the canopy height module 1604 associates a particular polygon with a maximum height of all the pixels encompassed by the polygon. In some embodiments, additionally or alternatively, the canopy height module 1604 associates a particular polygon with values representing one or more of the 99th, 98th, 95th, and 90th percentiles of all the pixels encompassed by the polygon. In some embodiments, the canopy height module 1604 associates a particular polygon with any value derived from the heights of all the pixels encompassed by the polygon, such as the average or the mean of all such pixel heights.

In some embodiments, the tree segmentation module 1606 may retrieve images (e.g., including or not including multispectral data and/or spectral signatures) or video from any number of multiple image sources 102. In one example, an image source 102 may provide satellite, aerial, and/or ground-level images and video. The images or video may be captured by different devices, such as satellites, airplanes, drones, image capture devices, surveillance cameras, and the like. Commercially available satellite images from companies such as AIRBUS AERIAL may provide a user interface or a web link to download satellite images of specific geographic areas.

In various embodiments, the tree segmentation module 1606 may interact with one or more of the image sources 102 to retrieve different images of the same geographic area and/or different geographic areas. For example, the tree segmentation module 1606 may retrieve one set of images taken by satellite(s) of a geographic area that is available through a first image source 102A and other images taken by an airplane of the same geographic area that is available through a second image source 102B.

In various embodiments, the tree segmentation module 1606 may request images based on geographic area (for example, coordinates), location information, date ranges, quality (for example, high quality or based on resolution), enhancement, orientation, and/or the like.

In some embodiments, the tree segmentation module 1606 may provide an Application Programming Interface (API) call to a software application that provides satellite images. In some embodiments, the tree segmentation module 1606 may receive enhanced and aligned images from a satellite image source such as Google Maps. In various embodiments, the tree segmentation module 1606 may determine if images require enhancement. In some embodiments, the tree segmentation module 1606 may utilize computer vision techniques and deep learning models to determine if the quality of images may be improved.

In some embodiments, the tree segmentation module 1606 may optionally scan any number of images, remove noise, remove undesired markings provided by the service, improve accuracy, balance or remove color, or the like. In some embodiments, the spatial resolution of images captured by the different image sources 102 is different. The tree segmentation module 1606 may utilize techniques such as histogram equalization, contrast enhancement, bilinear interpolation, or some combination thereof to generate high-resolution images from low-resolution images.

In some embodiments, the tree segmentation module 1606 generates one or more segmentation maps by providing images to multiple fully convolutional networks (FCNs) which classify pixels in the images as trees or non-trees to obtain multiple intermediate segmentation maps, and provides the multiple intermediate segmentation maps to an ensemble FCN that combines the multiple intermediate segmentation maps to obtain the one or more segmentation maps. In some embodiments, the tree segmentation module 1606 generates rasters of the geographic region based on the segmentation maps and the images. In some embodiments, the tree segmentation module 1606 generates vectors based on the rasters of the geographic region.

In some embodiments, the tree segmentation module 1606 receives a set of georeferenced satellite images of a geographic region. The geographic region may include multiple geographic areas, and the multiple geographic areas may include multiple electrical assets of one or more power distribution infrastructures. A georeferenced satellite image, which is in the form of a rectangle, includes the coordinates of the top-left vertex and the bottom-right vertex of the rectangle. Accordingly, the coordinate of each pixel in the georeferenced satellite image may be determined using the vertex coordinates and the resolution of the georeferenced satellite images. The georeferenced satellite images may be mono, where a satellite captures one image of a particular area. Alternatively, the georeferenced satellite images may be stereo, where the satellite captures two images of a particular area from two different angles at approximately the same time. The tree segmentation module 1606 may use georeferenced stereo satellite images to create digital surface models.

The tree segmentation module 1606 may generate segmentation maps by providing the set of georeferenced mono satellite images to one or more fully convolutional networks (FCNs). In some embodiments, the tree segmentation module 1606 uses multiple FCNs, each of which is trained on data from a different georeferenced satellite image provider, and utilizes another FCN (termed an ensemble FCN) to combine the output of each of the multiple FCNs. In such embodiments, the tree segmentation module 1606 may provide the output of each of the multiple FCNs as input to the ensemble FCN. The ensemble FCN combines the output of each of the multiple FCNs so as to produce a segmentation map that is more accurate than that which would be produced by a single one of the multiple FCNs. In some embodiments, the tree segmentation module 1606 utilizes a single FCN to perform the segmentation. In such embodiments, the single FCN may not necessarily be as accurate as the ensemble FCN, but may be selected for various reasons, such as case of use, reduction in training time, and/or reduction in inference time.

The tree segmentation module 1606 may generate one or more rasters of the geographic region based on the segmentation map and the set of georeferenced satellite images. A raster is an image that has metadata of coordinates usable to determine the locations of the pixels in the images. The tree segmentation module 1606 may locate each pixel in the raster based on the dimensions and location information of the georeferenced satellite images. The tree segmentation module 1606 may perform a binary classification of each pixel in the raster as either a tree or not a tree (and/or vegetation or non-vegetation). The tree segmentation module 1606 may group tree pixels as trees. The raster may, in some embodiments, include other trees.

The tree segmentation module 1606 may generate one or more vectors based on the one or more rasters of the geographic region. A vector includes one or more polygons (or a linestream or a single point), with a polygon representing a tree and having a set of coordinates that define the polygon. A vector may include multiple polygons. Because a polygon is defined by a set of coordinates, it is possible for the tree segmentation module 1606 to calculate the two-dimensional surface area of the polygon (a calculated area), which may be used as an estimate of the tree crown area.

In one example, the tree segmentation module 1606 may receive images, such as satellite images, from different third-parties. For example, the tree segmentation module 1606 may receive georeferenced satellite images from multiple satellite image third parties. However, the georeferenced satellite images may not necessarily be uniform in all their characteristics or parameters. For example, a particular satellite image third party may provide georeferenced satellite images that have a particular contrast or resolution. Another satellite image third-party may provide georeferenced satellite images at a different contrast or resolution and/or a different illumination angle. For example, a set of georeferenced satellite images from a first satellite image third party may have intensity values ranging from 0 lux to 1000 lux. Another set of georeferenced satellite images from a first satellite image third party may have intensity values ranging from 0 lux to 5 lux. Accordingly, there can be significant differences in the characteristics and/or parameters of georeferenced satellite images that the image retrieval module 204 receives. These significant differences may be such that using a single neural network to perform tree segmentation may provide results that do not meet a required level of accuracy. Accordingly, it would be useful to have a framework that is robust enough to be able to perform tree segmentation to a desired level of accuracy using heterogenous georeferenced satellite images.

In some embodiments, the tree segmentation module 1606 uses multiple neural networks, such as multiple FCNs, to perform vegetation segmentation, and an ensemble FCN to combine the outputs of the multiple FCN. Each of the multiple FCNs has been trained on georeferenced satellite images from a particular satellite image third party. For example, a first FCN is trained on georeferenced satellite images from a first satellite image third party, a second FCN is trained on georeferenced satellite images from a second satellite image third party, and so forth. Each of the multiple FCNs may therefore be trained so as to perform tree segmentation to a required degree of accuracy on the georeferenced satellite images from a particular satellite image third-party. Due to this particularized training, one of the multiple FCNs may not necessarily perform tree segmentation to the required degree of accuracy on the georeferenced satellite images from the other satellite image third-parties. To overcome this particular technical problem, the tree segmentation module 1606 may use a single neural network, termed an ensemble FCN, to combine the output of the multiple FCNs and to generate the one or more segmentation maps to generate the one or more rasters.

In one example, each of many FCNS may have single input layer (input_1:Input_Layer) that takes as input a four-band satellite image. The input data of the first input layer has a shape of (batch size, image height, image width, and the number of channels), and the output data has the same shape. In this example, the value of the batch size question mark (“?”) may be a batch size value that depends upon the number of images in the batch. In some embodiments, one or more FCNs has a single input layer. In some embodiments, one or more FCNs have as many as three additional input layers (input_2:InputLayer, input_3:InputLayer, and input_4:InputLayer). In such embodiments, the input data to the three additional input layers are heat maps that are usable as additional signals to the FCN(s) for tree segmentation. A layer, for example, may have the shape of (batch size, image height, image width, and the number of channels), or of several of (batch size, image height, image width, and the number of channels), and the output data has the same shape. As with the first input layer, the value of the batch size is a question mark (“?”) as the batch size depends upon the number of images in the batch. The FCN(s) may provide as output a single-band satellite image, with each pixel classified as either a tree or not a tree, in the form of an intermediate segmentation map.

The tree segmentation module 1606 may utilize an ensemble FCN to combine the output of the multiple FCNs. In one example, an ensemble FCN has six input layers. The input_6 input layer takes as input the georeferenced satellite image. The input_7, input_8, input_9, input_10, and input_11 input layers take as input the output of each of the multiple FCNs, that is, the multiple intermediate segmentation maps. The input data of a layer has a shape of (batch size, image height, image width, and the number of channels), or of several of (batch size, image height, image width, and the number of channels), and the output data has the same shape. The value of the batch size is none.

In some embodiments, the tree segmentation module 1606 provides the georeferenced satellite image as input to the input_6 input layer so as to provide information that the ensemble FCN may use to weight input layers input_7 through input_11. For example, for a first set of georeferenced satellite images from a first satellite image third-party, the input_7 and input_9 input data, which corresponds to the output of a first FCN and a third FCN, might be quite accurate, while the input_8, input_10, and input_11 input data might not need a desired degree of accuracy. Accordingly, the ensemble FCN may weight input layers input_7 and input_9 more and the ensemble FCN may weight input layers input_8, input_10, and input_11 less. The architecture of the ensemble FCN allows for the combination of the outputs of each FCN so as to result in a required degree of accuracy for tree segmentation. Accordingly, the tree segmentation module 1606 may generate a segmentation map in which pixels are classified as either trees or non-trees to a required degree of accuracy.

In some embodiments, the tree segmentation module 1606 may confirm that one tree or a group of trees are in two or more images or multispectral data by applying registration techniques. For example, a first image and a second image may be obtained. The first image is a reference image that serves as ground truth data. The second image is an image to be evaluated with respect to the first image for alignment. For example, the first image may be a satellite image of a geographic region and the second image may also be a satellite image of the geographic region captured at a different point in time. Tiles for the first image and the second image may be generated. The first image may be divided into a grid of tiles and the second image may be divided into a corresponding grid of tiles having a consistent size. Subsequently, one or more respective alignment offsets may be measured between each of a plurality of tiles associated with the second image and corresponding tiles associated with the first image. Each of the plurality of tiles may then be classified as aligned or misaligned. The classification may be based on the respective alignment offsets measured between the plurality of tiles associated with the second image and the corresponding tiles associated with the first image. Subsequently, a determination may be made that at least a threshold amount of tiles associated with the second image satisfy a tile threshold. The second image may be co-registered with the first image based at least in part on the determination that the classified plurality of tiles associated with the second image satisfy the tile threshold to confirm that the tree or group of trees are in multiple images an the information used to assist in the canopy height measurement, polygon estimation, DBH calculation, and/or the like.

In another example, a first image and a second image may be obtained. The first image is a reference image that serves as ground truth data. The second image is an image to be evaluated with respect to the first image for alignment. For example, the first image may be a satellite image of a geographic region and the second image may also be a satellite image of the geographic region captured at a different point in time. Tiles for the first image and the second image may be generated. The first image may be divided into a grid of tiles and the second image may be divided into a corresponding grid of tiles having a consistent size. One or more respective alignment offsets may be measured between each of a plurality of tiles associated with the second image and corresponding tiles associated with the first image. Subsequently, each of the plurality of tiles may be classified as aligned or misaligned. The classification may be based on the respective alignment offsets measured between the plurality of tiles associated with the second image and the corresponding tiles associated with the first image. As follows, a determination may be made that the classified plurality of tiles associated with the second image satisfy a tile threshold. The second image may be categorized as being misaligned with respect to the first image based at least in part on the determination that the classified plurality of tiles associated with the second image satisfy the tile threshold.

In some embodiments, the carbon dioxide estimation system 1600 may utilize one or more artificial intelligence (AI) and/or machine learning (ML) models to identify hazard trees from images, such as satellite images with a 30 cm resolution. For example, the carbon dioxide estimation system 1600 may utilize one or more convolutional neural networks (CNNs) and/or one or more fully convolutional neural networks (FCNNs) to process images for purpose of identifying hazard trees. A CNN and/or FCNN may be based on a U-Net architecture and may include an encoder and a decoder. In various embodiments, the encoder may be derived from a Resnet50V2 model that has been trained on an ImageNet dataset. In some embodiments, the decoder may include five layers of blocks, and the carbon dioxide estimation system 1600 may up-sample the blocks using nearest point interpolation. One advantage of using nearest point interpolation is that it may improve reliability of the CNN and/or FCNN model for images of a wider range of geographic areas. In some embodiments, the carbon dioxide estimation system 1600 may up-sample the blocks using transposed convolution.

The carbon dioxide estimation system 1600 may utilize one or more generative adversarial networks (GANs) to train the CNN and/or FCNN against adversarial noise and to provide improved generalisability for images of a wider range of geographic areas. The carbon dioxide estimation system 1600 may improve the one or more GANs using a combination of a Lovasz-Softmax loss and a cross-entropy loss. One advantage of utilizing a Lovasz-Softmax loss is that it is a tractable surrogate for intersection over union (IoU) measure as compared to a dice loss which corresponds to a per-pixel loss. Since the hazard trees may be small in size on images with 30 cm resolution or lower, IoU loss used in this training strategy may allow the carbon dioxide estimation system 1600 to ignore noise in the labelled dataset and at the same time provide inferences that may provide higher quality instance segmentation of hazard trees. In some embodiments, the carbon dioxide estimation system 1600 may utilize only a Lovasz-Softmax loss. In one example, a function for cross-entropy loss that the carbon dioxide estimation system 1600 may utilize is given by equation (1):

$${L}_{CE} ( y , \hat{y} ) = - {\sum }_{i} {ω}_{i} [ {y}_{i} log {\hat{y}}_{i} + ( 1 - {y}_{i} ) log ( 1 - {\hat{y}}_{i} ) ] \qquad ( 1 )$$

In equation (1), ω may be the weights per pixel, yᵢ may be the ground truth pixel values and ŷᵢ may be the model predictions.

The carbon dioxide estimation system 1600 may calculate weights per image to emphasize the edges of the trees that are to be detected via the model. In some embodiments, the carbon dioxide estimation system 1600 may calculate the weights by: 1) finding boundaries of polygons using morphological operations to produce another image I and 2) convolving image I with a gaussian kernel which the carbon dioxide estimation system 1600 then scales by a constant parameter to produce a weights image W containing weights ωᵢ.

In some embodiments, the carbon dioxide estimation system 1600 may utilize only a cross-entropy loss. In various embodiments, the carbon dioxide estimation system 1600 may, additionally or alternatively, utilize other loss functions.

In some embodiments, after receiving the images, the carbon dioxide estimation system 1600 (for example, the tree segmentation module 1606) may process the images for the geographic area. For example, an image may include multiple channels, such as a red channel, a green channel, and a blue channel. Each pixel of the image may have an intensity value for each of the multiple channels. The intensity values may range from zero (0) to 255 or from zero (0) to another value (for example, 4,096) for each channel. The carbon dioxide estimation system 1600 may normalize the intensity values of pixels of the image so that, for each pixel, the pixel has an intensity value for each channel of the multiple channels that ranges between zero (0) and one (1).

In some embodiments, the carbon dioxide estimation system 1600 may process the images for a geographic area by calculating a 50th percentile of intensity values and a 90th percentile of intensity values. The carbon dioxide estimation system 1600 may use the 50th percentile of intensity values and the 90th percentile of intensity values that the carbon dioxide estimation system 1600 had previously calculated for the multiple images (e.g., FIG. 8A depicts an example processing block 800 for processing images according to some embodiments). The carbon dioxide estimation system 1600 may process images in other ways, such as by resizing the images, cropping the images, modifying the resolution of images, and/or other ways.

In some embodiments, the carbon dioxide estimation system 1600 (for example, the tree segmentation module 1606) may perform inference on the images for the geographic area. In some embodiments, the carbon dioxide estimation system 1600 classifies, using one or more trained AI and/or ML models (for example, using one or more convolutional neural networks and/or one or more fully convolutional neural networks) the pixels of each image of the multiple images as tree pixels.

In some embodiments, the carbon dioxide estimation system 1600 utilizes a test-time augmentation framework to classify pixels of images. The test-time augmentation framework may include an augmentation layer, one or more trained AI and/or ML models (for example, the U-Net encoder and decoder layers of the convolutional neural network 900 of FIG. 9), and a de-augmentation layer. Test-time augmentation may allow for capturing the output of the one or more trained AI and/or ML models under different conditions. In some embodiments, the carbon dioxide estimation system 1600 (for example, the tree segmentation module 1606) performs test-time augmentation on an image by performing one or more transformations on the image to generate one or more transformed images, which may be referred to as augmentation. The one or more transformations of the image that the carbon dioxide estimation system 1600 may perform on the image may include one or more rotations of the image (for example, 90 degrees clockwise, 90 degrees counter-clockwise, or 180 degrees), one or more flips of the image (for example, about the horizontal axis of the image or about the vertical axis of the image), one or more of resizing the image (for example, to a smaller size and/or a larger size), and one or more additions of noise to the image.

The carbon dioxide estimation system 1600 may then process the one or more transformed images and the image using the one or more trained AI and/or ML models to generate one or more first intermediate values for each pixel of the image. The carbon dioxide estimation system 1600 may then modify the one or more first intermediate values so as to undo the effect of the one or more transformations on the image, thereby obtaining one or more second intermediate values. For example, where the carbon dioxide estimation system 1600 has rotated an image 90 degrees clockwise, the carbon dioxide estimation system 1600 may rotate the second intermediate values 90 degrees counterclockwise. The carbon dioxide estimation system 1600 undoing the effect of the one or more transformations may be referred to as de-augmentation. The carbon dioxide estimation system 1600 may then apply a statistical function on the one or more second intermediate values to obtain third intermediate values. For example, the carbon dioxide estimation system 1600 may average the one or more second intermediate values to obtain the third intermediate values. The carbon dioxide estimation system 1600 may then classify each pixel of the image based on the third intermediate values as a tree and/or vegetation (or non-tree or non-vegetation) pixel.

One output of the carbon dioxide estimation system 1600 classifying pixels of an image using one or more trained AI and/or ML models may include a probability data structure that has dimensions that are sized the same as the dimensions of the image. For example, the probability data structure may have the same number of rows as the width of the image in pixels and the same number of columns as the height of the image in pixels. The probability data structure may include, for each pixel of the image, a probability value that indicates a probability that the pixel is of a portion of a tree. In some embodiments, the probability value may be between zero (0) and one (1). The carbon dioxide estimation system 1600 may generate multiple probability data structures by processing the multiple images using the one or more trained AI and/or ML models.

In some embodiments, the carbon dioxide estimation system 1600 (for example, the model inference module 208) may generate multiple classification data structures based on the multiple probability data structures. A classification data structure may have dimensions that are sized the same as the dimensions of the image (for example, the classification data structure may have the same number of rows as the width of the image in pixels and the same number of columns as the height of the image in pixels). The carbon dioxide estimation system 1600 may generate a classification data structure by iterating through a probability data structure and comparing each probability value to a threshold value (for example, 0.5). If the carbon dioxide estimation system 1600 determines that the probability value is equal to or greater than the threshold value, the carbon dioxide estimation system 1600 may classify the pixel corresponding to the probability value as a tree pixel. If the carbon dioxide estimation system 1600 determines that the probability value is less than the threshold value, the carbon dioxide estimation system 1600 may classify the pixel corresponding to the probability value. The carbon dioxide estimation system 1600 may generate a classification data structure that includes, for each pixel of the image, the classification of the pixel as a hazard tree pixel or as a non-hazard tree pixel. The carbon dioxide estimation system 1600 may generate a classification data structure for each image of the multiple images, thereby generating multiple classification data structures.

The carbon dioxide estimation system 1600 may digitize trees using the tree pixels. For example, the carbon dioxide estimation system 1600 may generate multiple polygons based on the hazard tree pixels, where a polygon corresponds to one or more hazard trees in an image. For a polygon, the carbon dioxide estimation system 1600 may identify or determine a set of coordinates that define the polygon. In some embodiments, the carbon dioxide estimation system 1600 may utilize morphological operations to find boundaries of a polygon. For example, the carbon dioxide estimation system 1600 may remove noisy pixels using morphological operations, which may reduce false positives. U.S. patent application Ser. No. 18/167,830, filed Feb. 10, 2023 and entitled SYSTEMS AND METHODS FOR IDENTIFYING TREES AND ESTIMATING TREE HEIGHTS AND OTHER TREE PARAMETERS, describes techniques for digitizing trees and is incorporated in its entirety by reference herein. The carbon dioxide estimation system 1600 may map the polygons to a georeferenced coordinate system by transforming the geometry of the polygons with an appropriate projection matrix.

The carbon dioxide estimation system 1600 may determine or identify metrics for multiple polygons. For example, for a polygon, the carbon dioxide estimation system 1600 may determine a two-dimension area of the polygon using the set of coordinates that define the polygon. The carbon dioxide estimation system 1600 may also apply a statistical function to the probabilities of the pixels of the polygon to determine a value. For example, the carbon dioxide estimation system 1600 may average the probabilities of the pixels of the polygon to determine an average probability (a mean probability) for the polygon. The carbon dioxide estimation system 1600 may also assign one or more unique identifiers to the polygon.

In various embodiments, after the carbon dioxide estimation system 1600 has digitized hazard trees, one or more quality checks may be performed to remove false positives and correct false negatives. The performance of a quality check may include a person reviewing representations of classification data structures and images previously received in some embodiments. In various embodiments, the carbon dioxide estimation system 1600 may perform the quality check by, for example, comparing classification data structures with ground truth determinations of trees to ensure that the numbers or percentages of false positives and the numbers or percentages of false negatives are within appropriate ranges and/or do not meet or exceed appropriate values.

The carbon dioxide estimation system 1600 may receive the multiple polygons previously generated. The carbon dioxide estimation system 1600 may determine the heights of polygons. In some embodiments, the carbon dioxide estimation system 1600 may utilize one or more canopy height models (CHMs) to determine the heights of the polygons. The carbon dioxide estimation system 1600 may generate the one or more CHMs using the techniques described in the above-referenced U.S. patent application Ser. No. 18/167,830. Additionally or alternatively, the carbon dioxide estimation system 1600 may obtain the one or more CHMs from one or more of the image sources 102.

For a polygon corresponding to or representing one or more trees, the carbon dioxide estimation system 1600 may utilize the one or more CHMs to determine a height for each pixel of the polygon. The carbon dioxide estimation system 1600 may then determine one or more metrics for the polygon based upon the heights of each pixel encompassed by the polygon. For example, the carbon dioxide estimation system 1600 may determine an average (mean), a 50th percentile, an 85th percentile, a 90th percentile, a 95th percentile, and/or the like. The carbon dioxide estimation system 1600 may assign one or more of the metrics to the polygon as one or more heights of the polygon.

The tree family classification module 1608 may identify and classify tree families within a geographic area based on remote sensing data. It performs the role of the tree family classification model 1706 in some embodiments by integrating data from several sources: canopy height maps (e.g., from canopy height model 1702), multispectral spectral signatures (e.g., from externally sourced data and images), polygon data (e.g., from the individual tree segmentation model 1704).

To generate tree family classifications, the tree family classification module 1608 may employ one or more AI models, such as deep neural networks or random forest classifiers. The tree family classification module 1608 may process raw and/or engineered features (e.g., including tree height, canopy width, canopy shape/geometry, and near-infrared (NIR) bands) to distinguish between different tree families. The final output of the module may be a classification of tree famil(ies) present in the assessed imagery.

The tree species classification module 1610 may identify and classify specific tree species within a given geographic area by analyzing remote sensing and segmentation data. Functionally aligned with the tree species classification model 1708, the tree species classification module 1610 may use input from the canopy height map (generated by the canopy height model 1702), multispectral data (e.g., spectral signatures from external imagery), and polygon data (from the individual tree segmentation model 1704) to perform its classification tasks. The tree species classification module 1610 may employ a pipeline of AI models, such as deep neural networks or random forests, to process raw and/or engineered features (e.g., including tree height, canopy width, canopy shape/geometry, and near-infrared (NIR) bands) which help distinguish between species.

In some embodiments, the tree species classification module 1610 leverages the output of the tree family classification model 1706 to inform the selection of a suitable species detection model. By narrowing the classification scope to species within a known tree family, the system enhances accuracy, scalability, and efficiency. The end result is the generation of a species classification of tree species in the analyzed area.

The tree DBH module 1612 may perform the function of the tree DBH model 1710 in some embodiments. The tree DBH module 1612 may determine a diameter to breast height metric (e.g., to identify the diameter to breast height of one or a group of trees of the natural environment) utilizing CHM data, and the segmentation (e.g., tree polygons).

The tree DBH module 1612 may utilize species coefficients (e.g., based on the species identified by the species classification model 1708) to determine the DBH.

The Tree Species Tariff module 1614 may retrieve tariff numbers based on the identified species of the tree(s). The tariff numbers may assist in calculating tree volume, biomass, carbon, and carbon dioxide.

In some embodiments, the tree volume module 1616 calculates a volume of the tree. The tree volume module 1616 may use the two-dimensional surface area of the polygon representing the tree and the maximum height of the tree to calculate the volume of the tree. The tree volume module 1616 may use the formula for the volume of a cone,

$$V = \frac{1}{3} π {r}^{2} h ,$$

to calculate the volume of the tree (e.g., if the tree is a generally conical shape).

In some embodiments, the tree species classification module 1610 identifies a species of the tree and, based on the species, the tree volume module 1616 may utilize the species of the tree in calculating the volume of the tree as well as the density of the tree. For example, certain species may have a generally conical shape. Other species may have a generally cylindrical shape. The species of trees may be determined using AI. The tree volume module 1616 may access the data storage 1624 to obtain the species of a particular tree, and use a volume formula for the shape corresponding to the species in order to calculate the volume of the particular tree. In some embodiments, the tree volume module 1616 may access the data storage 1624 to obtain a mass of a tree using the species of the tree. For example, the data storage 1624 may include data relating tree height and/or tree area to tree mass. The tree volume module 1616 may calculate the tree density using the tree mass and the tree volume.

The tree biomass module 1618 generates estimates of trunk biomass and biomass of trees and/or vegetation.

The carbon dioxide estimation module 1620 generates estimates of carbon dioxide and/or carbon dioxide equivalent estimations stored in the natural environment as discussed herein.

The notification module 1622 provides a notification of the estimates of carbon dioxide. The notification module 1622 may provide the notification in the form of an email or other text-based message, a spreadsheet listing geographic areas and estimated carbon dioxide content, changes in estimated carbon dioxide content over time for any number of geographic areas, and/or the like. It will be appreciated that the notification module 1622 may use a variety of means of providing notifications.

In some embodiments, the systems and methods described herein allow for a scalable and accurate identification of trees across any geographic region on Earth and the storing of digital representations (in the form of polygons) of trees and tree parameters such as tree crown area. Another advantage of some embodiments is that systems and methods discussed herein may enable an accurate estimation of tree heights and other tree parameters such as tree volume and tree density. Further, some embodiments allow for the identification of trees and groups of trees based on tree height.

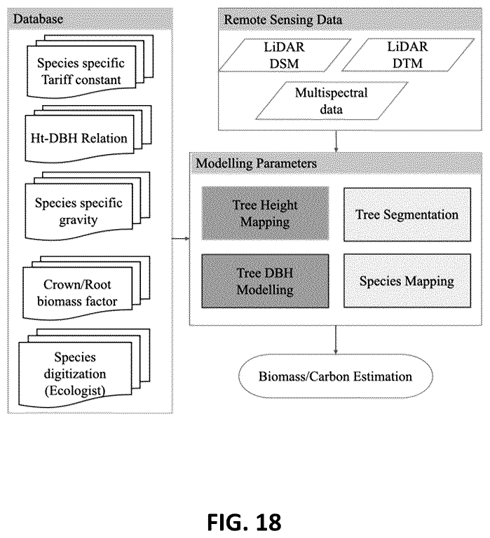

FIGS. 17A and 17B is a system diagram for estimating carbon dioxide in a natural environment in some embodiments. The natural environment may include any non-urban environment. In one example, the natural environment is a woodland or any environment with trees. As discussed herein, FIG. 18 depict an overview of a biomass/carbon estimation in some embodiments. In some embodiments, one or more external databases may provide species-specific tariff constant(s), Ht-DBH relation (e.g., tree height to diameter breast height relationship), species-specific gravity, crown/root biomass factor, and/or species digitization. The species digitization may, in some embodiments, be created by one or more ecologists.

By leveraging LiDAR DSM, LIDAR DTM, and the multispectral data with the external information and tree segmentation as discussed herein, a tree height map is created. Once the tree height map is created, tree heights can be converted to DBH for one or more trees (or groups of trees) (e.g., using the DBH modelling shown in FIGS. 17A and 17B). In some embodiments, the tree DBH modelling may use species mapping and the tree height map to generate DBH.

It will be appreciated that a database may provide different information (e.g., species-specific tariff constant(s), Ht-DBH relation, species-specific gravity, crown/root biomass factor, and/or species digitization) or one or more databases may provide one or more of the different types of information.

Based on the tree height mapping and DBH, the system may derive the tariff constants (e.g., as discussed with respect to FIGS. 17A and 17B) and using the factorization component, the system may derive crown and/or root biomass factors. Using the specific species-specific gravity, volume may be converted into a biomass estimate which may be used to estimate carbon dioxide equivalent.

It will be appreciated that there may be many different government-backed standards for woodland creation projects to sequester carbon dioxide from the atmosphere. Systems and methods discussed herein may be used to calculate sequestration of carbon dioxide in a natural environment, changes in sequestration of carbon dioxide over time, and changes in sequestration of carbon dioxide due to man-made improvements to the land.

For example, the Woodland Carbon Code (WCC) is the UK's government-backed standard for woodland creation projects that aim to sequester carbon dioxide (CO₂) from the atmosphere. Established in 2011 and managed by Scottish Forestry, the WCC provides a robust and transparent framework for ensuring that such projects are scientifically sound, responsibly managed, and independently verified. This gives assurance to both landowners and carbon credit buyers that projects meet high environmental standards. Beyond carbon sequestration, these woodland projects contribute to biodiversity, water quality, flood mitigation, and community engagement.

The Code applies to voluntary woodland creation efforts across the UK, whether through planting, natural regeneration, or direct seeding. Landowners or farmers looking to participate must follow a structured process: register their project on the UK Land Carbon Registry within two years of planting, undergo independent validation within three years, and periodically verify actual carbon sequestration beginning in year five. Based on these verified results, participants can earn Woodland Carbon Units (WCUs), which may be sold to generate income or offset emissions.

For those looking to invest in carbon credits, the WCC provides a reliable and transparent avenue. Buyers can purchase WCUs to mitigate their own unavoidable UK-based emissions, while also supporting projects that yield measurable environmental and social benefits. All projects are held to stringent standards that ensure permanence, additionality, and traceable carbon removals. This system aligns with the UK's broader net-zero targets and helps link local environmental action with the global climate agenda.

Participation in the WCC can also offer financial incentives. In England, the government operates the Woodland Carbon Guarantee (WCaG), which provides landowners with the option to sell verified carbon credits back to the government at a guaranteed price. This creates long-term revenue potential and reduces the financial risk of woodland creation. As of early 2025, over 2,100 WCC projects have been validated, covering more than 35,000 hectares and projected to sequester over 11.7 million tonnes of CO₂ over their lifetimes—an important contribution to the UK's net-zero strategy.

It will be appreciated that this is only one example of many different incentives. Other incentives may include marketing, compliance with corporate and environmental regulations, and being good stewards of the land and environment.

In some embodiments, systems and methods discussed herein utilize four different models: 1) an individual tree segmentation model; 2) a tree height mapping model; 3) a species mapping model; and 4) a model for conversion of height to diameter at breast height (DBH). The features that may be utilized in the models include: 1) DSM (Digital Surface Model), 2) DTM (Digital Terrain Model), 3) CHM (Canopy Height Model), 4) DBH (Diameter at Breast Height), and 5) species model.

The canopy height module 1702 may generate a canopy height map. A canopy height map indicates the calculated height of a canopy based on LiDAR DSM and LiDAR DTM. In some embodiments, the canopy height module 1702 may receive one or more digital surface models (DTMs) of the geographic region.

The modules work together to process and analyze woodland data. The Communication Module 1602 handles data input and transmission between components. The Canopy Height Module 1604 and Tree Segmentation Module 1606 process spatial data, while the classification modules (1608, 1610) analyze tree characteristics. The Tree DBH Module 1612 and Tree Species Tariff Module 1614 perform specific measurements and calculations.

The Tree Volume Module 1616 and Biomass Module 1618 compute volumetric and mass data, while the Carbon Dioxide Equivalent Module 1620 calculates carbon metrics. The Notification Module 1622 manages system alerts and communications. All processed data is stored in the Data Storage 1624.

In various embodiments, the tree segmentation module 1606 performs the function of the individual tree segmentation model 1704. In various embodiments, the tree segmentation module 1606 identifies texture(s) in images (e.g., multispectral data) of geographic areas to determine changes in pixel values and identifies edges. In various embodiments, the tree segmentation module 1606 utilizes CNN or FNN models (although any AI or combination of AI models may be applied).

In various embodiments, the tree segmentation module 1606 receives the canopy height map (e.g., CHM data) from the canopy height model 1702 and assesses the CHM data of a particular geographic region for peak local maxima to identify tree boundaries. Texture may be identified through the RGB values, contrast, and homogeneity against neighboring pixels. Local minimas are, for example, those pixels that are lower than their surrounding pixels within a defined window or area. These local minimas are likely to lie between tree crowns. In various embodiments, the tree segmentation module 1606 may utilize watershed segmentation, inverted the CHM so tree tops become valleys, and valleys become ridges. The tree segmentation module 1606 may use local minima as markers for segmentation to delineate tree crowns.

In some embodiments, the tree segmentation module 1606 may complete incomplete canopies. In various embodiments, the tree segmentation module 1606 identifies individual trees or groups of trees, applies geometry from dense trees to identify further trees from dense geometry to complete the boundary polygons. For example, after tree segmentation, the tree segmentation module 1606 may identify individual trees and clusters of trees. Clusters typically consist of multiple trees detected as a single unit. To separate these, the geometries of nearby individual tree outside the cluster may be used as references. These surrounding trees help guide the splitting of the cluster into distinct individual tree geometries.

In various embodiments, the tree family classification module 1608 performs the function of the tree family classification model 1706 in some embodiments. For example, the tree family classification module 1608 may utilize the canopy height map from the canopy height model 1702, the multispectral data (e.g., spectral signatures) from the externally received data and images, and the polygon data form the individual tree segmentation model 1704 to identify and/or detect tree famil(ies) of the geographic area in the image(s) being assessed.

The tree family classification module 1608 may utilize one or more AI models (e.g., a pipeline of mixed models including, but not limited to a deep neural network) to create tree family classifications. In some embodiments, the tree family classification module 1608 utilizes a random forest to identify and/or classify tree families.

In various embodiments, the tree family classification module 1608 utilizes received and/or engineered features to detect tree families. Examples of such features include, but are not limited to, height, canopy width, canopy geometry (e.g., points that lie on the canopy boundaries), and/or near infrared bands. The output of the tree family classification module 1608 is a family classification.

In various embodiments, the tree species classification module 1610 performs the function of the tree species classification model 1708 in some embodiments. For example, like the tree family classification model 1706, the tree species classification module 1610 may utilize the canopy height map from the canopy height model 1702, the multispectral data (e.g., spectral signatures) from the externally received data and images, and the polygon data form the individual tree segmentation model 1704 to identify and/or detect tree spec(ies) of the geographic area in the image(s) being assessed.

The tree species classification module 1610 may utilize one or more AI models (e.g., a pipeline of mixed models including, but not limited to a deep neural network) to create tree species classifications. In some embodiments, the tree species classification module 1610 utilizes a random forest to identify and/or classify tree species.

In various embodiments, the tree family classification module 1608 utilizes received and/or engineered features to detect tree species. Examples of such features include, but are not limited to, height, canopy width, canopy geometry (e.g., points that lie on the canopy boundaries), and/or near infrared bands.

The tree species classification module 1610 may identify one or more trained species detection models (e.g., random forests) based on the tree family classification from the tree family classification model 1706. It will be appreciated that by using the tree family, the selection of the tree species (e.g., the species itself or an applicable trained model) becomes more accurate, the system becomes more scalable, and the process more efficient.

The tree species classification module 1610 provides a species map.

In various embodiments, the tree DBH module 1612 performs the function of the tree DBH model 1710 in some embodiments. The tree DBH module 1612 utilizes CHM data, and the segmentation (e.g., tree polygons) to identify tree polygon level canopy height(s) for individual trees and/or groups of trees.

The tree DBH module 1612 may utilize species coefficients (e.g., based on the species identified by the species classification model 1708) to determine the DBH. For example, the tree DBH module 1612 may apply the linear formula:
DBH=a₀+(a₁×Height)+(a₂×Crown Width), where the three constants are available from the species coefficients.

The tree DBH module 1612 utilizes the following equation to determine the tree DBH

$$DBH = Height / ( H / D ratio )$$

In some embodiments, the tree DBH module 1612 utilizes the species-specific coefficients that utilize the crown diameter to determine the DBH:

$$DBH = {b}_{0} \times {( Crown Width )}^{⋀} {b}_{1}$$

Where the variables are from the species-specific coefficients retrieved from external sources. In some embodiments, the tree DBH module 1612 utilizes the existing dataset to determine if region-specific equations/models may be generated using these equations that are closer to the ground truth.

In one example, for an Oak tree, these formulas are:

$$DBH = 3.098 + ( 0.9616 \times Height ) + ( 0.7224 \times Crown Width )$$

$$DBH = Height / 40 ( The H / D Ratio is 40 - 70 )$$

$$DBH = 6.067 \times {( Crown Width )}^{⋀} 0.846$$

The tree segmentation model 1606 may identify individual trees in the remote sensing data. The model improves segmentation by combining multiple images in a way not done before—optical with LiDAR to determine the boundaries of individual tree canopies. This approach allows for more accurate identification of individual trees compared to traditional methods.

The canopy height module 1604 may use the DSM and DTM data to calculate the height of different points on the tree canopy to create a height model for the tree. Once a tree height map is established, there are datasets which give calculations of tree height and also DBH. Using those datasets, if tree height is known, DBH can be derived.

The tree species classification model 1708 may classify the species of each identified tree. The model may use an ensemble approach to improve species identification. In some embodiments, the tree species classification model 1708 creates and expands the ensemble of models to do better classification of family and species for trees. In one example, the ensemble of models segregates the identified trees, classifies them by family, and then identifies the species. This approach allows for significant improvement in identification accuracy and enables continuous updates with fine-tuning at a species level.

In some embodiments, the system can identify over 250 species common across UK and USA (48 states) with over 80% accuracy, as compared to the traditional ground-based methods. It can further identify an additional 110 species at 60-80% accuracy. This covers over 60% of tree species found in the UK and about 40% of the species in the contiguous USA.

In some embodiments, the technology may utilize labeled training data for the species detection model. Certain areas may have a limited number of species of trees. For example, there may be ten species of trees that are most prevalent in a specific geographic area. The species detection model may be weighted toward these ten species or limited to these ten species.

The tree DBH model 1710 may convert tree height to diameter at breast height (DBH). There is a relationship between DBH and tree height, which allows for the calculation of DBH from tree height data. Once a tree DBH is established and the tree species identified, the tariff constant and the crown/root biomass factors may be established.

The tariff model 1712 may determine a tree specifies-specific tariff number. The tree species tariff module 1614 may perform one or more of the functions of the tariff model 1712. There are species-specific tariff constants for trees. For example, a specific species such as teak may have a tariff constant that varies with age. That is, when teak is growing, there is a growth factor with respect to age. The quadratic mean of measurements may be utilized, so that a single measurement may be converted into a biomass or a volume component.

In various embodiments, tariff numbers of forestry refer to species-specific constants used to estimate tree volume, biomass, and/or growth based on easily measured attributes like diameter at breast height (DBH) and height. These constants are commonly used in tree volume equations and taper equations. In forestry, a tariff number is a classification that assigns a specific volume or form factor to a species or group of trees, often by region. It simplifies the process of estimating timber volume without having to measure each tree in detail. In various embodiments, species-specific constants for tariff numbers may be provided by a service as discussed herein, a government agency, forest inventory data, and/or the like.

Tariff numbers may be used to estimate volume by assigning a number (e.g., tariff number 28, 30, 32, etc.) based on tree form, taper, and species. These are used particularly in British and Commonwealth countries. Tariff Tables/Volume Tables are created from empirical measurements that link DBH and sometimes height to expected volume, indexed by tariff number.

In various embodiments, depending upon the tree species classification, the tree species tariff module 1614 may apply the broad-leaved tree tariff number calculation or the conifer tree tariff number calculation. Although there are only two tariff number calculations depicted in FIG. 17B, it will be appreciated that the tree species tariff module 1614 may perform any number of different calculations for different tree species (i.e., the tree species tariff module 1614 is not limited to broad-leaved trees and conifers).

### Broad-Leaved Tree Tariff Number Calculation

$$T = a 1 + ( a 2 \times h ) + ( a 3 \times dbh ) + ( a 4 \times h \times dbh )$$

### Conifer Tree Tariff Number Calculation

$$T = a 1 + ( a 2 \times h ) + ( a 3 \times dbh )$$

The tariff model 1712 (e.g., via the tree species tariff module 1614) may output the tree species-specific tariff number (i.e., the Broad-leaved Tree Tariff Number Calculation, the Conifer Tree Tariff Number Calculation, or other tree-specific calculations).

There are also species-specific gravity values for trees—a specific gravity of each of the species, which indicates how dense a tree is. The amount of biomass in a tree will differ depending on the species.

The tree volume model 1714 may determine a tree volume. In one example, the tree volume module 1616 performs the function of the tree volume model 1714. For example, the tree volume model 1714 may receive the tree species-specific tariff number from the tariff model 1712. For example, the tree volume module 1616 may determine tree volume constants using T. For example, constants a1 and a2 may be determined as follows:

$$a 1 = ( 0.0360541 \times T ) - ( a 2 \times 0.1182 \; 88 )$$

$$a 2 = 0. 315049309 \times ( T - 0.138763302 )$$

The tree volume module 1616 may then calculate the tree volume V as follows:

$$V = a 1 + a 2 \times ba$$

The trunk biomass may be calculated using the tree volume and the specific gravity. The crown biomass may be calculated. The total biomass may be calculated as the sum of the trunk biomass and the crown biomass.

For example, the biomass module 1618 may determine the trunk biomass by adding the volume from the tree volume model 1714 to specific gravity. Thereafter, the biomass module 1618 may determine the biomass by adding the trunk biomass to the crown biomass. The crown biomass may be determined by the biomass module 1618 as follows:

$$Crown {Biomass}_{( dbh > 50 cm )} = a + b \times dbh$$

$$Crown {Biomass}_{( dbh < 50 cm )} = b \times {dbh}^{p}$$

The crown biomass factor may be received from any number of external sources. For example, the crown biomass factor may be retrieved from scientific literature, US forest service, IPCC Guidelines, national and/or regional forestry databases, and/or the like. In some embodiments, a crown biomass factor is a species- or group-specific coefficient used to estimate the biomass of a tree's crown (e.g., branches and foliage), typically as a function of the stem biomass, DBH, height, or total aboveground biomass.

Carbon may be calculated as half of the biomass. The CO2 equivalent may be calculated as carbon multiplied by a factor (for example, 44/12).

The carbon dioxide estimation module 1620 may determine an estimate of carbon by multiplying the biomass from the biomass module 1618 by a constant or function (e.g., here, in FIG. 17B, the factor is 0.5).

The carbon dioxide estimation module 1620 may estimate carbon dioxide based on the carbon estimate by multiplying the carbon estimate by 44/12.

In various embodiments, the carbon dioxide estimation system 1600 may provide a dashboard that displays or reports the estimated carbon dioxide sequestration of any number of natural environments. In various embodiments, the notification module 1622 stores all evaluations, tariff values, DBH, species classification, family classification, volumes, biomass calculations, and/or the like in the data storage 1624 for tracking, historical comparisons, compliance, and/or auditing.

It will be appreciated that the carbon dioxide estimation system 1600 may track historical changes of carbon dioxide sequestration for the same or adjacent regions (e.g., woodlands) over time. For example, the carbon dioxide estimation system 1600 may receive remote sensing data (e.g., images, spectral images, DSMs, and/or the like) for different time periods and assess the carbon dioxide sequestration changes. If there are significant changes of carbon dioxide sequestration (e.g., the carbon dioxide estimation module 1620 compares values against a threshold that signifies a significant change in increase or decrease), the notification module 1622 may generate an emergency notification to review results to confirm accuracy and/or take further action for remediation. It will be appreciated that the carbon dioxide estimation system 1600 may evaluate a particular geographic area over time to establish a rate of expected change. If an owner or manager of the region takes steps to improve carbon dioxide sequestration, then the carbon dioxide estimation system 1600 can identify those changes that are a result of those steps (e.g., by comparing the expected rate of natural change relative to actual values after positive action has been taken). As such, the notification module 1622 may identify and report improvements to carbon dioxide sequestration that are a result of such actions for carbon credits, compliance, auditing, environmental, and/or marketing reasons.

As discussed herein, the carbon dioxide estimation system 1600 may utilize optical images with additional bands available along with aerial LiDAR data. This may be coupled with several additional datasets—like DSM, DTM, soil data, weather data, local environment records, and generic and species-specific datasets.

As discussed herein, the carbon dioxide estimation system 1600 may utilize the following data in some embodiments: A) Aerial—LiDAR—Digital Surface Model (DSM). B) Aerial—LiDAR—Digital Terrain Model (DTM). C) Ground level species—Vector data. D) Databases: 1) Tree height and GBH database (Generic and species-specific). 2) Tree species specific—Specific Gravity (density). 3) UK-Woodland Carbon Code databases. 3a) Constants for tariff number. 3b) Crown/Root biomass expansion factors (species-specific).

The carbon dioxide estimation system 1600 may utilize satellite images captured over periods of time to perform multiple biomass and/or carbon calculations for a geographic area. For example, in year zero for a geographic area, saplings may be planted, and satellite images of the geographic area may be utilized to determine the biomass of the saplings. In subsequent years (for example, 10 years in), satellite images may be used to determine the increase in biomass and thus the increase in carbon dioxide equivalent.

The subsequent satellite images may also be utilized to answer questions such as: 1) How many trees have survived? 2) How many have been thinned out? 3) How big are the trees? 4) What's the carbon that has been supplanted in that 10-year period? The net difference is the carbon credit that may be sold by the owner of the geographic area.

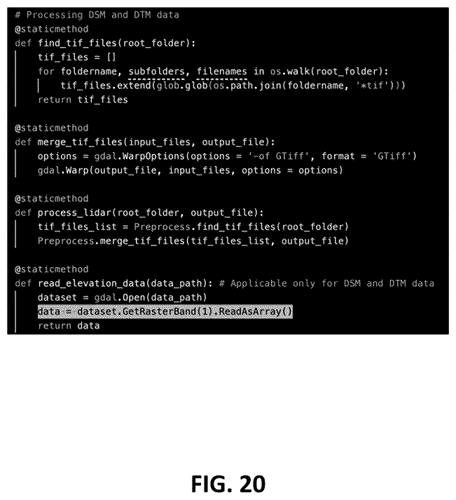

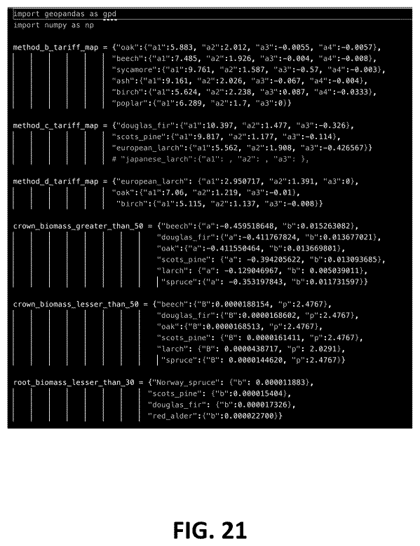

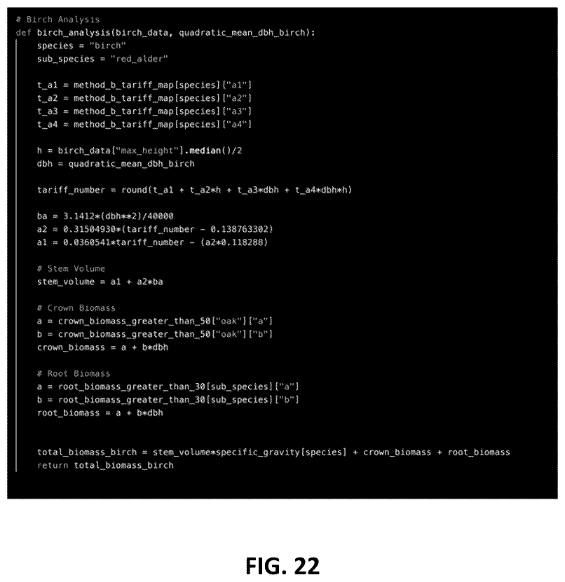

FIGS. 20-22 depict example code that may be utilized in some embodiments. FIG. 20 depicts example code that may be utilized to create and/or populate a database that may store values for tariff number and crown and/or root biomass calculations. FIG. 21 depicts example code that may be utilized to process remote sensing data such as satellite images. FIG. 22 depicts example code that may be utilized to perform biomass and/or carbon calculations.

FIG. 18 depicts examples of a tree height map, tree segmentation, and a species map generated by the systems and methods discussed with regard to FIGS. 17A and 17B in some embodiments.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure.

It will be appreciated that aspects of one or more embodiments may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a solid state drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program or data for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++, Python, or the like and conventional procedural programming languages, such as the “C” programming language or similar programming languages. The computer program code may execute entirely on any of the systems described herein or on any combination of the systems described herein.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented concurrently or in parallel or may be performed at different times. Further any specific numbers noted herein are only examples: alternative implementations may employ differing values or ranges.

Throughout this specification, plural instances may implement components, operations, or structures described as a single instance. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. Furthermore, any specific numbers noted herein are only examples: alternative implementations may employ differing values or ranges.

Components may be described or illustrated as contained within or connected with other components. Such descriptions or illustrations are examples only, and other configurations may achieve the same or similar functionality. Components may be described or illustrated as “coupled,” “couplable,” “operably coupled,” “communicably coupled” and the like to other components. Such description or illustration should be understood as indicating that such components may cooperate or interact with each other, and may be in direct or indirect physical, electrical, or communicative contact with each other.

Components may be described or illustrated as “configured to,” “adapted to,” “operative to,” “configurable to,” “adaptable to,” “operable to” and the like. Such description or illustration should be understood to encompass components both in an active state and in an inactive or standby state unless required otherwise by context.

The use of “or” in this disclosure is not intended to be understood as an exclusive “or.” Rather, “or” is to be understood as including “and/or.” For example, the phrase “providing products or services” is intended to be understood as having several meanings: “providing products,” “providing services,” and “providing products and services.”

It may be apparent that various modifications may be made, and other embodiments may be used without departing from the broader scope of the discussion herein. For example, although determining potential hazards to electrical assets of electrical utilities and to assets (for example, pipelines) of other utilities (for example, natural gas distribution utilities) may be described, the systems and methods described herein may be applicable to determining potential hazards and/or risks to any structure (for example, antennas, buildings, roads, etc.) posed by hazard trees.

Therefore, these and other variations upon the example embodiments are intended to be covered by the disclosure herein.

1. A non-transitory computer-readable medium comprising executable instructions, the executable instructions being executable by one or more processors to perform a method, the method comprising:
receiving remote sensing data of the geographic area;
generating a canopy height model using digital surface model (DSM) data and digital terrain model (DTM) data;
identifying individual trees in the geographic area using a tree segmentation model that combines optical and LiDAR data to determine boundaries of individual tree canopies;
determining heights of the identified individual trees using the canopy height model;
converting the heights to diameter at breast height (DBH) values;
classifying species of the identified individual trees using a species classification model that segregate identified trees, classify them by family, and then identify species;
calculating biomass for each of the identified individual trees based on the DBH values, the heights, and species-specific factors; and
calculating carbon dioxide sequestration based on the calculated biomass.

2. The non-transitory computer-readable medium of claim 1, wherein the species-specific factors include at least one of: species-specific tariff constants, species-specific gravity values, and crown/root biomass expansion factors.

3. The non-transitory computer-readable medium of claim 1, the method further comprising receiving ground-based sample measurements for a subset of trees in the geographic area; and calibrating at least one of the tree segmentation model and the species classification model using the ground-based sample measurements.

4. The non-transitory computer-readable medium of claim 1, the method further comprising receiving temporal remote sensing data of the geographic area captured at different time periods; and calculating changes in carbon sequestration over time based on the temporal remote sensing data.

5. The non-transitory computer-readable medium of claim 1, wherein calculating biomass comprises: calculating trunk biomass using tree volume and species-specific gravity; calculating crown biomass using species-specific crown biomass expansion factors; and calculating total biomass as a sum of the trunk biomass and the crown biomass.

6. The non-transitory computer-readable medium of claim 1, wherein calculating carbon sequestration comprises: calculating carbon as a proportion of the calculated biomass; and calculating carbon dioxide equivalent by multiplying the calculated carbon by a conversion factor.

7. The non-transitory computer-readable medium of claim 1, further comprising: stratifying the geographic area into homogeneous regions based on tree characteristics; calculating carbon sequestration for each of the homogeneous regions; and combining carbon sequestration values for the homogeneous regions to determine total carbon sequestration for the geographic area.

8. The non-transitory computer-readable medium of claim 1, wherein the species classification model is trained using labeled data for tree species prevalent in the geographic area.

9. A system comprising at least one processor and memory containing executable instructions, the executable instructions being executable by the at least one processor to:
receive remote sensing data of the geographic area;
generate a canopy height model using digital surface model (DSM) data and digital terrain model (DTM) data;
identify individual trees in the geographic area using a tree segmentation model that combines optical and LiDAR data to determine boundaries of individual tree canopies;
determine heights of the identified individual trees using the canopy height model;
convert the heights to diameter at breast height (DBH) values;
classify species of the identified individual trees using a species classification model that segregate identified trees, classify them by family, and then identify species;
calculate biomass for each of the identified individual trees based on the DBH values, the heights, and species-specific factors; and
calculate carbon dioxide sequestration based on the calculated biomass.

10. The system of claim 9, wherein the species-specific factors include at least one of: species-specific tariff constants, species-specific gravity values, and crown/root biomass expansion factors.

11. The system of claim 9, the executable instructions being further executable by the at least one processor to further receive ground-based sample measurements for a subset of trees in the geographic area, and calibrate at least one of the tree segmentation model and the species classification model using the ground-based sample measurements.

12. The system of claim 9, the executable instructions being further executable by the at least one processor to further receive temporal remote sensing data of the geographic area captured at different time periods; and calculate changes in carbon sequestration over time based on the temporal remote sensing data.

13. The system of claim 9, wherein calculating biomass comprises: calculating trunk biomass using tree volume and species-specific gravity; calculating crown biomass using species-specific crown biomass expansion factors; and calculating total biomass as a sum of the trunk biomass and the crown biomass.

14. The system of claim 9, wherein calculating carbon sequestration comprises: calculating carbon as a proportion of the calculated biomass; and calculating carbon dioxide equivalent by multiplying the calculated carbon by a conversion factor.

15. The system of claim 9, the executable instructions being further executable by the at least one processor to further stratify the geographic area into homogeneous regions based on tree characteristics; calculate carbon sequestration for each of the homogeneous regions; and combine carbon sequestration values for the homogeneous regions to determine total carbon sequestration for the geographic area.

16. The system of claim 9, wherein the species classification model is trained using labeled data for tree species prevalent in the geographic area.

17. A method comprising:
receiving remote sensing data of the geographic area;
generating a canopy height model using digital surface model (DSM) data and digital terrain model (DTM) data;
identifying individual trees in the geographic area using a tree segmentation model that combines optical and LiDAR data to determine boundaries of individual tree canopies;
determining heights of the identified individual trees using the canopy height model;
converting the heights to diameter at breast height (DBH) values;
classifying species of the identified individual trees using a species classification model that segregate identified trees, classify them by family, and then identify species;
calculating biomass for each of the identified individual trees based on the DBH values, the heights, and species-specific factors; and
calculating carbon dioxide sequestration based on the calculated biomass.
